(19) United States
(12) Patent Application Publication
(10) Pub. No.: US 2016/0041311 A1
(43) Pub. Date: Feb. 11, 2016

(54) Compound Eye Optical System And Imaging Device

(71) Applicant: KONICA MINOLTA, INC., Tokyo (JP)

(72) Inventors: Shoji KOGO, Chiyoda-ku, Tokyo (JP); Makoto JIN, Chiyoda-ku, Tokyo (JP); Kenji KONNO, Chiyoda-ku , Tokyo (JP); Takashi KAWASAKI, Chiyoda-ku, Tokyo (JP)

(21) Appl. No.: 14/779,503

(22) PCT Filed: Mar. 14, 2014
(86) PCT No.: PCT/JP2014/056851

§ 371 Date: Sep. 23, 2015

(30) Foreign Application Priority Data
Mar. 26, 2013 (JP) 2013-063922

(51) Int. Cl. G02B 3/00; G02B 27/00; G02B 13/00; H04N 5/232; G06T 5/50

(52) U.S. Cl. CPC G02B 3/0043; H04N 5/23238; G06T 5/50; G02B 3/0056; G02B 13/005; G02B 27/0025; G06T 2207/20212

(57) ABSTRACT

Provided is a compound optical system that can obtain high-resolution images by solving the problem of aberration in a field-of-view separation-type optical system, and that enables a super thin image pickup device to be achieved. Also provided is an image pickup device using the compound optical system. With respect to the image pickup range of a central individual-eye lens, by narrowing the image pickup range of a peripheral individual-eye lens, the field curvature amount at the image pickup region can be reduced, and therefore, the eccentricity amount of the lens surface (or the lens group) can be reduced. As a result, an individual-eye lens with little defocus and good image forming characteristics can be obtained, and a compound optical system with favorable image forming characteristics can be configured.

### TECHNICAL FIELD

The present invention relates to an imaging device including an image processing section which is configured to connect multiple images with respective different view fields formed on a single solid state imaging sensor and to output an image on a single sheet, and relates to a compound eye optical system used for it.

### BACKGROUND ART

In recent years, thin type mobile terminals each equipped with an imaging device, represented by smart phones, tablet type personal computers, and the like, have spread rapidly. However, the imaging device mounted on such a thin type mobile terminal is required to be thin and compact while having high resolution. In order to respond to such a request, the overall length of imaging lenses has been shortened by the optical design, and precision in manufacturing has been improved so as to cope with an increase in error sensitivity due to the shortened overall length. However, with the conventional constitution in which an image is obtained with a combination of a single imaging lens and an imaging sensor, there may be a limitation. Accordingly, an optical system which changes the concept of the conventional optical system will be expected.

In contrast, in an optical system called a compound eye optical system, an imaging region of an imaging sensor is divided, multiple lenses (hereafter, called ommatidium lenses) are disposed for the respective divided imaging regions, and images obtained by the divided imaging regions are processed so as to output a final image. Such a compound eye optical system has been received a lot of attention in order to cope with a request to make an imaging device thinner (refer to PTL1).

### CITATION LIST

### Patent Literature

PTL1: Japanese Unexamined Patent Publication No. H10-145802

### SUMMARY OF INVENTION

### Technical Problem

However, any of various kinds of compound eye optical systems proposed up to now has not be able to achieve an optical system of a ultra-thin type with high image quality. Description is given to the reasons. One of the factors which deteriorate optical performances includes an image surface curvature. The image surface curvature means a state where an image surface is curved, that is, a state where an image surface is shown with a broken line in FIG. 1(a). In FIG. 1(a), as an angle · of a light ray B entering a lens L becomes larger (as an object becomes closer to a periphery), an image forming position changes from an on-axis (a view angle=0) best image forming position. Accordingly, in the case where an imaging surface of a solid state imaging sensor CCD is arranged at an on-axis best image forming position, even if the image forming performance of the center of the imaging surface is good, an image becomes out of focus (defocus) on the peripheral portions. In particular, as a range (D=an amount of an image surface curvature) of an image forming position deviation associated with a view angle change becomes larger, the image forming performance tends to deteriorate more. FIG. 1(b) shows a comparison between a MTF value at an on-axis best image forming position and a MTF value on a position which deviates by D from the on-axis best image forming position.

Herein, in an optical system of a view field division type, as an ommatidium lens is arranged closer to a periphery, the view angle of a light flux entering the ommatidium lens becomes larger. Accordingly, a range of an image forming position deviation associated with a view angle change becomes larger. For example, in FIG. 2, an amount of an image surface curvature of an optical system A located on a peripheral side becomes larger (D_{B}<D_{A}) rather than that of an optical system B located on a central side, which results in a tendency that an image forming performance deteriorates (out of focus).

In many optical systems of a view field division type, in order to improve performance degradation due to this image surface curvature, a lens surface (or a lens group) of an ommatidium lens arranged on a periphery (other than the center) is made to eccentric so as to incline the curved image surface, thereby creating a state where an image is in-focus in a usable photographing range (refer to Patent Document 1). With this method, a focus position may be improved. However, as shown in FIG. 3, even if the optical axis of a lens is inclined by making its lens surface largely eccentric so as to make the on-axis best image forming position of an ommatidium lens closer, aberration to deteriorate an image forming performance occurs. Accordingly, there is no change in a tendency that as an ommatidium lens is arranged closer to a periphery, its image forming performance deteriorates more.

The present invention has been achieved in view of the problems of the conventional techniques, and an object of the present invention is to provide a compound eye optical system which can acquire a high quality image by solving the problem of aberration in an optical system of a view field division type and can attain an imaging device of an ultra-thin type, and to provide an imaging device employing it.

### Solution to Problem

A compound eye optical system according to the present invention is a compound eye optical system for use in an imaging device which includes an image processing section configured to connect images formed with respective different view fields on a single solid state imaging sensor so as to output an image formed on a single sheet, and comprises an array lens including multiple lenses which are formed integrally into a single sheet and have respective different optical axes, wherein multiple ommatidium lenses configured to form images correspondingly to respective view fields are constituted by the lenses of the array lens, and at least one of Formula (1) and Formula (2) is established.

·h_{—}c>·h_{—}d (1)

·v_{—}c>·v_{—}d (2)

·h_c: the horizontal direction photographing range of a central ommatidium lens located on a central side of the array lens
·h_d: the horizontal direction photographing range of a peripheral ommatidium lens located closer to a peripheral side of the array lens rather than the central ommatidium lens
·v_c: the vertical direction photographing range of the central ommatidium lens located on the central side of the array lens

·v_d: the vertical direction photographing range of a peripheral ommatidium lens located closer to the peripheral side of the array lens rather than the central ommatidium lens

On the assumption that the horizontal direction maximum photographing angle which enters an ommatidium lens is made to ·h_max, the minimum photographing angle is made to ·h_min, the vertical direction maximum photographing angle is made to ·v_max, and the minimum photographing angle is made to ·v_min, a horizontal direction photographing range in the photographing range of an ommatidium lens can be expressed as ·h=|tan·h_max−tan ·h_min|, and a vertical direction photographing range can be expressed as ·v=|tan·v_max−tan·v_min|. That is, Formula (1) means that the horizontal direction photographing range of a central ommatidium lens is equal to or more than the horizontal direction photographing range of a peripheral ommatidium lens, and Formula (2) means that the vertical direction photographing range of a central ommatidium lens is equal to or more than the vertical direction photographing range of a peripheral ommatidium lens.

In a compound eye optical system, as described in the above-mentioned conventional techniques, as compared with a central ommatidium lens, the image forming performance of a peripheral ommatidium lens tends to deteriorate. An amount of image surface curvature in a photographing range can be made smaller by narrowing the photographing range of a peripheral ommatidium lens as compared with the photographing range of a central ommatidium lens. Accordingly, an amount of eccentric of a lens surface (or a lens group) can be made smaller. As a result, the ommatidium lens can be made to have little defocus and a good image forming performance, and it becomes possible to constitute a compound eye optical system with a good image forming performance. In the case where the photographing range of an ommatidium lens arranged in the vicinity of a periphery is narrowed on the condition that the photographing ranges of a compound eye optical system is not changed, it is necessary to widen the photographing range of an ommatidium lens arranged in the vicinity of a center. However, since the lens arranged in the vicinity of a center has a margin in image forming performance comparatively relative to a lens arranged in the vicinity of a periphery, if the photographing range is made wide somewhat, deterioration in image forming performance does not become a large problem.

An imaging device according to the present invention includes the compound eye optical system, a solid state imaging sensor, and an image processing section.

### Advantageous Effects of Invention

According to the present invention, it becomes possible to provide a compound eye optical system which can acquire a high quality image by solving the problem of aberration in an optical system of a view field division type and can attain an imaging device of an ultra-thin type, and to provide an imaging device employing it.

### BRIEF DESCRIPTION OF DRAWINGS

FIGS. 1(a) and 1(b) are illustrations for describing an image surface curvature.

FIG. 2 is an illustration for describing an image surface curvature in an optical system of a view field division type and shows a state where a central object OBJ3 is formed as an image via an optical system C, an intermediate object OBJ2 is formed as an image via an optical system B, and a peripheral object OBJ2 is formed as an image via an optical system A.

FIGS. 3(a) and 3(b) are illustrations for describing correction of an image surface curvature by inclining a lens.

FIG. 4 is a drawing showing schematically an imaging device according to the present embodiment.

FIG. 5 is a cross sectional view of a compound eye optical system.

FIGS. 6(a) and 6(b) are plan views for describing a positional relationship between a compound eye optical system and an imaging region.

FIG. 7(a) is a schematic diagram showing a photographing range of a comparative example, FIG. 7(b) is a schematic diagram showing a photographing range of an example, and FIG. 7(c) is a plan view showing an arrangement of a compound eye optical system.

FIGS. 8(a), 8(b), 8(c), and 8(d) are diagrams where respective MTF values in photographing ranges D1, V1, H1, and C in comparative examples are graphed respectively.

FIGS. 9(a), 9(b), 9(c), and 9(d) are diagrams where respective MTF values in photographing ranges D1, V1, H1, and C in examples are graphed respectively.

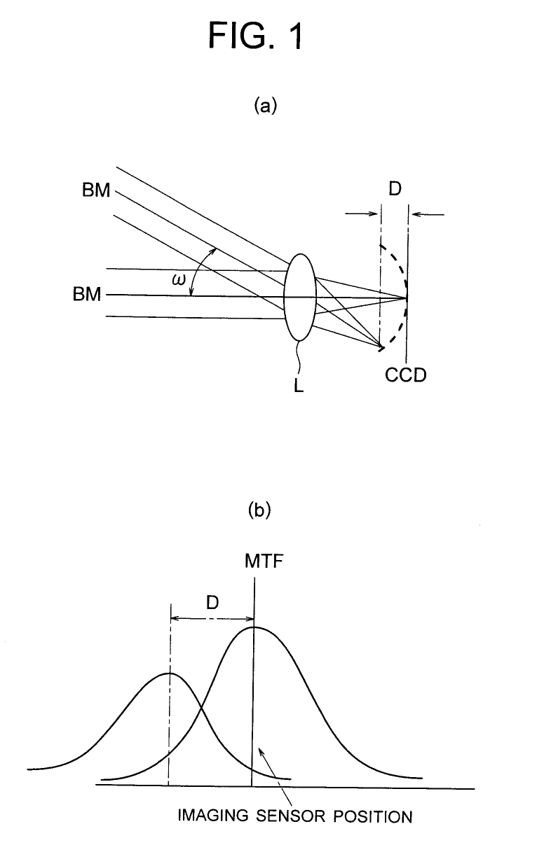

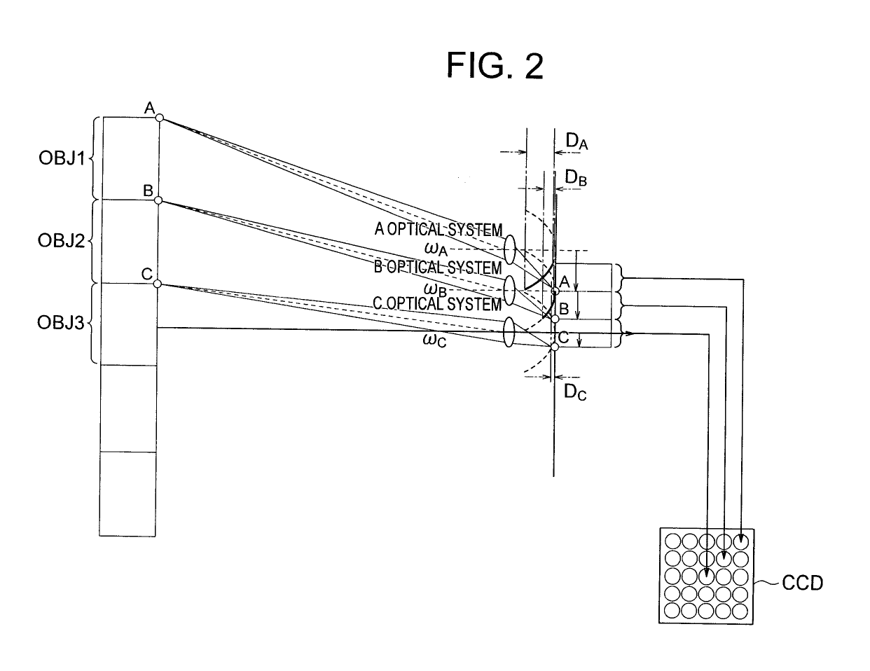

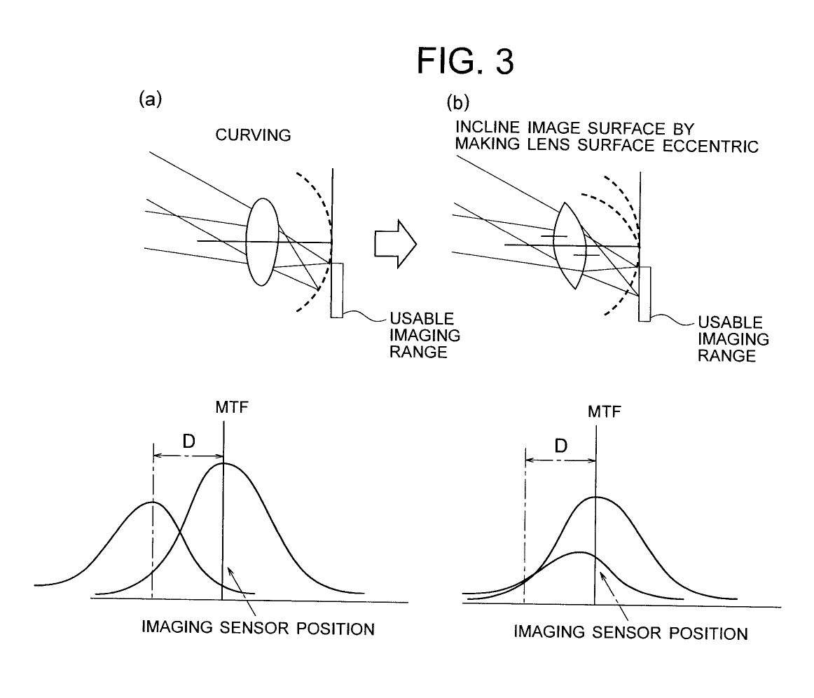

### DESCRIPTION OF EMBODIMENTS

Hereafter, description is given to a compound eye optical system according to the present invention and an imaging device using it. The compound eye optical system is an optical system in which multiple lens systems are arranged in a form of an array for a single imaging sensor, and the compound eye optical system is usually classified into a super resolution type in which each of the multiple lens systems is configured to image the same view field and a view field division type in which each of the multiple lens systems is configured to image a respective different view field. A compound eye optical system according to the present invention is configured to connect multiple images with the respective different view fields and to output a synthesized image formed on a single sheet. Accordingly, the compound eye optical system corresponds to the view field division type configured to form multiple images with the respective different view fields.

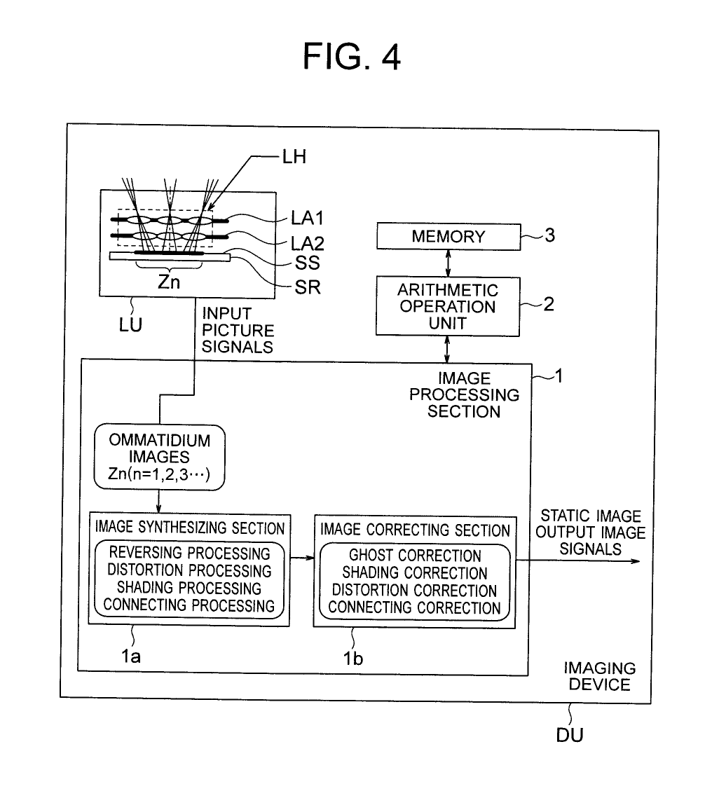

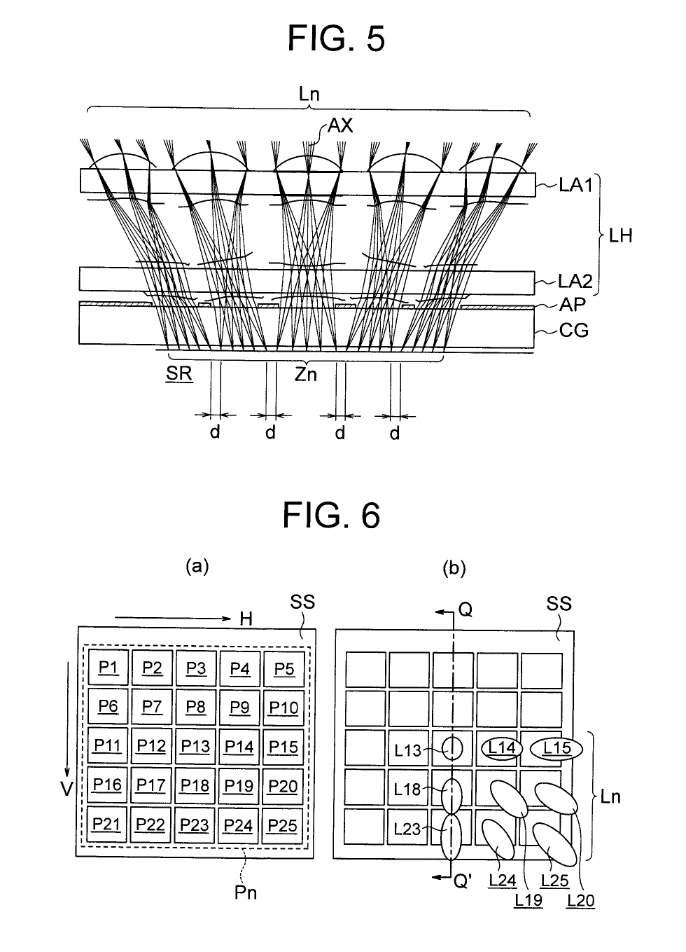

FIG. 4 shows schematically an imaging device according to the present embodiment, FIG. 5 is a cross sectional view of a compound eye optical system according to the present embodiment, and FIG. 6 shows a positional relationship between a compound eye optical system and an imaging region. As shown in FIG. 4, an imaging device DU includes an imaging unit LU, an image processing unit 1, an arithmetic operation unit 2, and a memory 3. The imaging unit LU includes a single imaging sensor SR and a compound eye optical system LH configured to form multiple images with the respective different view fields for the imaging sensor SR. As the imaging sensor SR, a solid state imaging sensor, such as a CCD type imaging sensor and a CMOS type imaging sensor each of which includes multiple pixels, may be used. The compound eye optical system LH is disposed so as to form optical images of an object on a light receiving section SS being a photoelectric converting section of the imaging sensor SR, and the optical images formed by the compound eye optical system LH are converted into electric signals by the imaging sensor SR.

As shown in FIG. 4 and FIG. 5, the compound eye optical system LH includes multiple ommatidium lenses Ln (n=1, 2, 3, . . . ) configured to form multiple ommatidium images Zn (n=1, 2, 3, . . . ) with the respective different view fields on the imaging surface SS of the imaging sensor SR. Each of the ommatidium lenses Ln includes two lenses of an object side lens and an image side lens. Accordingly, the compound eye optical system LH is constituted by a first lens array LA1 on which multiple object side lenses are formed integrally into a single body and a second lens array LA2 on which multiple image side lenses are formed integrally into a single body. As shown in FIG. 5, on the image side of the second lens array LA2, a cover glass CG of the imaging sensor SR is disposed, and on its image side surface, there is provided a light shielding member AP on which multiple openings are formed so as to transmit only image forming light rays from the respective ommatidium lenses Ln.

The object side lenses and the image side lenses formed respectively on the lens arrays LA1 and LA2 are stacked separately in the respective optical axis directions, thereby forming multiple ommatidium lenses configured to form multiple images with the respective different view fields on an imaging surface SS (for example, a photoelectric conversion unit of a solid state imaging device) of a single imaging sensor SR.

In FIG. 6(a), ommatidium regions Pn (n=1, 2, 3, . . . ) where ommatidium images Zn are formed on the imaging surface SS of the imaging sensor SR by the ommatidium lenses Ln are shown as imaging regions (a photographing range). In FIG. 6(b), a part (L13 to L15, L18 to L20, and L23 to L25) of the ommatidium lenses Ln to form the ommatidium images Zn (FIG. 4, FIG. 5) on the ommatidium regions Pn (FIG. 6(a)) is further shown. In addition, a circle shape in FIG. 6(b) shows a state of an ommatidium lens observed from the above side (for example, an ellipse shape shows an eccentric state of a lens system). Here, FIG. 5 corresponds to a cross sectional view taken along a Q-Q′ line in FIG. 6(b) (one cross section in the V direction). Since the ommatidium lenses Ln are arranged symmetrically in terms of vertical and lateral directions, FIG. 6(b) shows only ommatidium lenses Ln located at nine positions (L13 to L15, L18 to L20, and L23 to L25).

The first embodiment is constituted to perform a view field division in a matrix form of 5×5. Accordingly, as can be seen from FIG. 6, the ommatidium lenses Ln and the ommatidium regions Pn are arranged so as to correspond to the matrix form of 5×5. The respective magnifications of the ommatidium lenses Ln are almost equal to each other. An ommatidium lens L13 at the center (central ommatidium lens) is configured to form an image of a central portion of an object, and ommatidium lenses Ln at peripheral portions (peripheral ommatidium lenses other than L13) are configured to form respective images of peripheral portions of the object. Since a view field is divided, the angle of view of each of the ommatidium lenses Ln becomes narrow. Herein, on the assumption that the horizontal direction photographing range of a central ommatidium lens is made to ·h_c, the vertical direction photographing range of the central ommatidium lens DL1 is made to ·v_c, the horizontal direction photographing range of a peripheral ommatidium lens is made to ·h_d, and the vertical direction photographing range of the peripheral ommatidium lens DL2 is made to ·v_d, the following formulas are established.

·h_{—}c>·h_{—}d (1)

·v_{—}c>·v_{—}d (2)

As shown in FIG. 5, each of the ommatidium lenses Ln is constituted by two lenses, and the central ommatidium lens L13 (which has an optical axis AX vertical to the imaging surface SS) shown in FIG. 6 (b) has a telephoto type positive/negative power arrangement. Further, in each of the peripheral ommatidium lenses Ln other than the central ommatidium lens L13, each of four lens surfaces is made to a free curved surface. With the constitution that each of four lens surfaces is made to a free curved surface, it becomes possible to realize a very good aberration performance. In the ommatidium lenses Ln other than the central ommatidium lens L13, in order to constitute the respective peripheral view fields, the respective optical axes AX are made eccentric. Accordingly, it is not necessary to use a prism etc. for changing an optical path. Therefore, the respective thicknesses of the ommatidium lenses Ln can be made the same to each other, which makes it possible to design with the same board. Each of the ommatidium lenses Ln constituting the respective peripheral view fields makes a light flux obliquely enter the imaging surface SS. Accordingly, in order to secure the optical performance, at least two lenses are needed. Further, in order to obtain the same optical performance as that of an axially symmetric optical system, it is preferable to make each of four lens surfaces to a free curved surface. Furthermore, a light shielding member AP is arranged between the lens array LA2 and the imaging surface so as to use appropriately the imaging surface for the respective ommatidium lenses correspondingly to the photographing range. If a light flux enters an imaging surface from a lens other than an intended ommatidium lens (a cross talk occurs), an image may deteriorate. Accordingly, the light shielding member AP is configured to suppress this cross talk. It is preferable that the light shielding member is inserted not only between the ommatidium lenses and the imaging surface, but also inserted between lens arrays so as to prevent a cross talk from occurring as much as possible.

As shown in FIG. 4, the image processing section 1 includes an image synthesizing section 1a, an image correcting section 1b, and an output image processing section 1c. The image synthesizing section 1a is configured to connect multiple ommatidium images Zn (n=1, 2, 3, . . . ) which are formed by the compound eye optical system LH, are cut separately from each other by the light shielding member AP, and have the respective different view fields, and to output an ommatidium synthetic image ML of a single sheet. At that time, the image correcting section 1b is configured to perform reverse processing, distortion processing, shading processing, connecting processing, and the like. Further, the image correcting section 1b is configured to perform distortion correction as required.

### Example

Hereafter, description is further given concretely to examples suitable for the above-mentioned compound eye optical system by showing construction data and by comparing them with comparative examples. The examples shown in here are numerical examples corresponding to the above-mentioned embodiments, and the optical constitution diagram (FIG. 5) showing the embodiment of the compound eye optical system LH shows a lens constitution of the corresponding numerical examples, an optical path, and the like.

The area arrangement of the ommatidium lens Ln in the examples and the comparative examples is shown in Table 1. The ommatidium lenses Ln are arranged at 5×5 positions, and a whole optical system L0 is arranged at three positions. However, since the ommatidium lenses Ln are arranged symmetrically in vertical and horizontal directions, only nine positions (C, V1, V2, H1, H2, D1 D2, VD, and HD) are shown (common with the comparative examples).

TABLE 1
Area arrangement

| | | |
|---|---|---|
| V1 | VD | D1 |
| V2 | D2 | HD |
| C | H2 | H1 |

In the construction data of an ommatidium lens Ln (position: C) which is rotational symmetric around the optical axis AX, as face data, face number, radius of curvature r (mm), axial face distance d (mm), index of refraction nd in terms of d line (wavelength: 587.56 nm), and Abbe's number vd in terms of d line are shown sequentially in the order from a column on the left side. Further, in the construction data of an ommatidium lens Ln (position: V1, VD, D1, V2, D2, HD, H2, and H1) which is an eccentric optical system, as face data, face number, radius of curvature r (mm), axial face distance d (mm), and Y eccentricity (mm) are shown sequentially in the order from a column on the left side. The notation “90 degree rotation” on an ommatidium lens Ln means that a state where a face produced in accordance with the construction data is rotated by 90 degree around Z axis becomes the state of the lens. Therefore, in relation to an eccentric direction and a free curved surface coefficient, it becomes the same with the case where X and Y are replaced with each other (the H direction corresponds to the X direction, and the V direction corresponds to the Y direction).

In the central ommatidium lens Ln (position: C) which is rotational symmetric around the optical axis AX, an aspherical surface being rotational symmetric around the optical axis AX is used, and the aspherical surface is defined by the following formula (AS) using a local orthogonal coordinate system (X, Y, Z) in which an apex of its surface is made to the original point. In each of the peripheral ommatidium lenses Ln (position: V1, VD, D1, V2, D2, HD, H2, and H1) which is an eccentric optical system, a free curved surface is used, and the free curved surface is defined by the following formula (FS) using a local orthogonal coordinate system (X, Y, Z) in which an apex of its surface is made to the original point. As aspherical surface data, aspherical surface coefficients are shown, and as free curved surface data, free curved surface coefficients are shown (however, A (j, k) is represented by X^{j}·Y^{k}). Further, the coefficient of an item where there is no notation is 0; in all the aspherical surfaces, K=0; in both the X and Y directions in all the free curved surfaces, K=0; and in all the data, E−n=×10⁻ⁿ.

Z=(C0·h²)/[1+·{1−(1+K)·C0²·h²}]+·(A¹·h¹) (AS)

Z=(C0·h²)/[1+·{1−(1+K)·C0²·h²}]+·{A(j,k)·X^{j}·Y^{k}} (FS)

In the above formulas,

H: Height (h²=X²+Y²) in the vertical direction to the Z axis (the optical axis AX),

Z: Amount of a displacement in the Z axis direction at a position with a height of h (on the basis of an apex of a surface),

C0: Curvature on an apex of a surface (an inverse number of a radius of curvature r),

K: Conic constant,

Ai: i-th order aspherical surface coefficient, and

A(j, k): j-th in X and k-th in Y free curved surface coefficient.

The followings are the construction data of examples.

TABLE 2A
C

| FACE | RADIUS OF | | INDEX OF | ABBE'S |
|---|---|---|---|---|
| NUMBER | CURVATURE | DISTANCE | REFRACTION | NUMBER |
| 1 | 0.7197332 | 0.215 | 1.518 | 56.1 |
| 2 | inf | 0.305 | 1.510 | 62.4 |
| 3 | inf | 0.163 | 1.602 | 28.6 |
| 4 | 1.7029341 | 0.737 | | |
| 5 | −8.390263 | 0.050 | 1.602 | 28.6 |
| 6 | inf | 0.300 | 1.510 | 62.4 |
| 7 | inf | 0.050 | 1.518 | 56.1 |
| 8 | 1.6121656 | 0.150 | | |
| 9 | inf | 0.500 | 1.471 | 66.02 |
| 10 | inf | 0.050 | | |

| ASPHERICAL | | | | | | | | |
|---|---|---|---|---|---|---|---|---|
| SURFACE | | | | | | | | |
| COEFFICIENT | | | | | | | | |
| FIRST FACE | 4th | −9.581E−02 | 6th | 2.915E+00 | 8th | −1.822E+01 | 10th | 2.842E+01 |
| | 12th | 8.327E+01 | 14th | 2.749E+02 | 16th | −1.818E+03 | k | −2.168E−01 |
| FOURTH FACE | 4th | 2.846E−01 | 6th | −2.947E+00 | 8th | 3.243E+01 | 10th | 7.825E+01 |
| | 12th | −1.788E+03 | 14th | −9.950E+02 | 16th | 4.494E+04 | k | 1.067E+01 |
| FIFTH FACE | 4th | −1.292E+00 | 6th | 9.533E+00 | 8th | −1.489E+02 | 10th | 7.086E+02 |
| | 12th | 5.069E+03 | 14th | −6.688E+04 | 16th | 2.003E+05 | k | −2.000E+01 |
| EIGHTH FACE | 4th | −1.601E+00 | 6th | 2.856E+01 | 8th | −4.345E+02 | 10th | 3.583E+03 |
| | 12th | −1.537E+04 | 14th | 2.919E+04 | 16th | −1.234E+04 | k | −5.795E+00 |

| V1 180 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 1.3253842 | 0.180 | 0.000 | Y | −6.676E−02 | X2 | 4.321E−01 | Y2 | 4.519E−01 |
| 2 | inf | 0.305 | 0.048 | X2Y | −7.731E−02 | Y3 | −4.047E−02 | X4 | 4.352E−01 |
| 3 | inf | 0.038 | 0.048 | X2Y2 | 1.033E+00 | Y4 | 4.255E−01 | X4Y | −9.533E−02 |
| 4 | 0.6535776 | 0.817 | 0.085 | X2Y3 | −4.425E−01 | Y5 | −4.658E−02 | X6 | 9.645E−01 |
| 5 | 0.6059401 | 0.095 | 0.490 | X4Y2 | 1.337E+00 | X2Y4 | 1.567E+00 | Y6 | 5.307E−01 |
| 6 | inf | 0.300 | 0.490 | X6Y | −9.877E−01 | X4Y3 | −1.915E+00 | X2Y5 | −2.442E−01 |
| 7 | inf | 0.055 | 0.490 | Y7 | −1.503E−01 | X8 | −1.907E+00 | X6Y2 | 1.281E+01 |
| 8 | −0.459876 | 0.146 | 0.741 | X4Y4 | 2.700E+01 | X2Y6 | 1.019E+01 | Y8 | 1.495E+00 |
| 9 | inf | 0.500 | 0.941 | X8Y | −3.279E+00 | X6Y3 | 7.134E+00 | X4Y5 | 1.706E+00 |
| 10 | inf | 0.050 | 0.941 | X2Y7 | −6.838E+00 | Y9 | 1.346E−01 | X10 | 2.193E+01 |
| | | | | X8Y2 | 1.838E+01 | X6Y4 | −1.305E+02 | X4Y6 | −5.887E+01 |
| | | | | X2Y8 | −1.559E+01 | | | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −4.891E−02 | X2 | −2.170E−01 | Y2 | −2.401E−01 |
| | | | | X2Y | 2.075E−01 | Y3 | 4.235E−01 | X4 | 2.498E−01 |
| | | | | X2Y2 | 1.117E+00 | Y4 | 3.098E−01 | X4Y | 4.784E−01 |
| | | | | XZY3 | 1.366E+00 | Y5 | 7.727E−01 | X5 | 3.917E+00 |
| | | | | X4Y2 | 1.044E+01 | X2Y4 | 7.710E+00 | Y6 | 3.157E+00 |
| | | | | X6Y | 1.187E+01 | X4Y3 | 2.310E+01 | X2Y5 | 2.252E+01 |
| | | | | Y7 | 4.573E+00 | X8 | −2.191E+01 | X6Y2 | −1.112E+02 |
| | | | | X4Y4 | −1.869E+02 | X2Y6 | −1.345E+02 | Y8 | −2.577E+01 |
| | | | | X8V | −1.232E+02 | X6Y3 | −1.507E+02 | X4Y5 | −4.823E+02 |
| | | | | X2Y7 | 7.407E+01 | Y9 | 5.081E+01 | X10 | 2.809E+02 |
| | | | | X8Y2 | 1.565E+03 | X6Y4 | 4.347E+03 | X4Y6 | 5.417E+03 |
| | | | | X2Y8 | 1.454E+03 | Y10 | 2.472E+02 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | −5.497E−02 | X2 | −3.500E−01 | Y2 | −7.052E−01 |
| | | | | X2Y | −7.772E−01 | Y3 | −9.047E−02 | X4 | −2.194E+00 |
| | | | | X2Y2 | −2.047E+00 | Y4 | −1.434E+00 | X4Y | 1.158E+00 |
| | | | | X2Y3 | 3.344E+00 | Y5 | 1.271E+00 | X6 | 6.714E+00 |
| | | | | X4Y2 | 1.042E+00 | X2Y4 | 5.612E+00 | Y6 | −7.183E+00 |
| | | | | X6Y | 4.654E+00 | X4Y3 | −6.202E+00 | X2Y5 | 5.700E−01 |
| | | | | Y7 | 2.210E+01 | X8 | −2.404E+01 | X6Y2 | 2.165E+01 |
| | | | | X4Y4 | 7.387E+01 | X2Y6 | −1.496E+02 | Y8 | −9.489E+01 |
| | | | | X8Y | −4.118E−01 | X6Y3 | 4.941E+01 | X4Y5 | 8.414E+01 |
| | | | | X2Y7 | 1.867E+02 | Y9 | −3.905E+01 | X10 | 4.267E+01 |
| | | | | X8Y2 | −2.281E+02 | X6Y4 | −4.688E+02 | X4Y6 | −3.867E+02 |
| | | | | X2Y8 | 1.052E+02 | Y10 | 1.783E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 7.802E−02 | X2 | 2.005E+00 | Y2 | 1.249E−00 |
| | | | | X2Y | −1.750E+00 | Y3 | −5.213E−01 | X4 | −2.020E+00 |
| | | | | X2Y2 | 1.069E+00 | Y4 | 2.309E+00 | X4Y | 5.623E+00 |
| | | | | X2Y3 | 3.242E+00 | Y5 | 6.122E+00 | X5 | 3.730E+01 |
| | | | | X4Y2 | 1.030E+02 | X2Y4 | 3.423E+01 | Y6 | 1.375E+01 |
| | | | | X6Y | −3.357E+01 | X4Y3 | 1.286E+01 | X2Y5 | −3.201E+01 |
| | | | | Y7 | 2.719E+01 | X8 | −2.556E+02 | X6Y2 | −8.546E+02 |
| | | | | X4Y4 | −1.176E+03 | X2Y6 | 1.082E+02 | Y8 | −2.863E+02 |
| | | | | X8Y | 6.645E+01 | X6Y3 | 1.428E+02 | X4Y5 | −2.268E+02 |
| | | | | X2Y7 | 8.998E+02 | Y9 | −1.937E+03 | X10 | 9.931E+02 |
| | | | | X8Y2 | 3.057E+03 | X6Y4 | 7.717E+03 | X4Y6 | 4.265E+03 |
| | | | | X2Y8 | 5.660E+02 | Y10 | −2.942E+03 | | |

TABLE 2B

| V2 180 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | −0.912949 | 0.156 | 0.000 | Y | −8.886E−02 | X2 | 1.445E+00 | Y2 | 1.479E+00 |
| 2 | inf | 0.305 | 0.031 | X2Y | −1.539E−01 | Y3 | −5.806E−02 | X4 | [symbol] .892E−01 |
| 3 | inf | 0.017 | 0.031 | X2Y2 | 2.020E+00 | Y4 | 9.356E−01 | X4Y | −2.547E−01 |
| 4 | 0.4303733 | 0.864 | 0.050 | X2Y3 | −6.499E−01 | Y5 | −1.982E−01 | X6 | 1.064E+00 |
| 5 | 0.5082237 | 0.069 | 0.330 | X4Y2 | 2.356E+00 | X2Y4 | 2.777E+00 | Y6 | 1.029E+00 |
| 6 | inf | 0.300 | 0.330 | X6Y | −2.623E+00 | X4Y3 | −4.228E+00 | X2Y5 | −1.788E+00 |
| 7 | inf | 0.051 | 0.330 | Y7 | −9.016E−01 | X8 | 6.545E+00 | X6Y2 | 4.068E+01 |
| 8 | −0.460871 | 0.149 | 0.402 | X4Y4 | 6.898E+01 | X2Y6 | 3.409E+01 | Y8 | 7.163E+00 |
| 9 | inf | 0.500 | 0.510 | X8Y | −6.855E+00 | X6Y3 | −2.684E+01 | X4Y5 | −5.700E+01 |
| 10 | inf | 0.050 | 0.510 | X2Y7 | −4.657E+01 | Y9 | −6.052E+00 | X10 | 4.412E+00 |
| | | | | X8Y2 | −8.021E+00 | X6Y4 | −9.582E+01 | X4Y6 | −5.887E+01 |
| | | | | X2Y8 | 2.921E+01 | | | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −2.826E−02 | X2 | −5.387E−01 | Y2 | −5.449E−01 |
| | | | | X2Y | 1.955E−02 | Y3 | 3.460E−01 | X4 | −3.926E−01 |
| | | | | X2Y2 | −3.185E−01 | Y4 | −3.630E−01 | X4Y | 8.838E−02 |
| | | | | X2Y3 | 1.065E+00 | Y5 | 3.886E−01 | X6 | 3.583E+00 |
| | | | | X4Y2 | 1.677E+01 | X2Y4 | 1.100E+01 | Y6 | 6.323E+00 |
| | | | | X6Y | −1.654E+00 | X4Y3 | −4.963E+00 | X2Y5 | 3.653E+00 |
| | | | | Y7 | 1.207E+01 | X8 | −4.630E+01 | X6Y2 | −4.202E+02 |
| | | | | X4Y4 | −5.618E+02 | X2Y6 | −1.816E+02 | Y8 | −1.216E+02 |
| | | | | X8Y | −1.215E+02 | X6Y3 | −1.867E+02 | X4Y5 | −1.593E+02 |
| | | | | X2Y7 | −9.072E+01 | Y9 | −5.382E+01 | X10 | 5.335E+02 |
| | | | | X8Y2 | 4.968E+03 | X6Y4 | 1.122E+04 | X4Y6 | 8.728E+03 |
| | | | | X2Y8 | 2.265E+03 | Y10 | 9.681E+02 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | 2.841E−02 | X2 | −5.593E−01 | Y2 | −7.797E−01 |
| | | | | X2Y | −4.385E−01 | Y3 | 1.598E−01 | X4 | −2.197E+00 |
| | | | | X2Y2 | −2.784E+00 | Y4 | −9.980E−01 | X4Y | 7.564E−01 |
| | | | | X2Y3 | 5.450E−01 | Y5 | 3.640E+00 | X6 | 2.318E+00 |
| | | | | X4Y2 | −8.118E+00 | X2Y4 | −1.964E+01 | Y8 | −1.884E+00 |
| | | | | X6Y | 8.509E+00 | X4Y3 | 5.344E+01 | X2Y5 | −2.831E+00 |
| | | | | Y7 | −2.508E+01 | X8 | −4.990E+00 | X6Y2 | 1.004E+02 |
| | | | | X4Y4 | 2.454E+02 | X2Y6 | 1.200E+02 | Y8 | −5.217E+01 |
| | | | | X8Y | −3.584E+01 | X8Y3 | −1.139E+02 | X4Y5 | −3.531E+02 |
| | | | | X2Y7 | 3.321E+02 | Y9 | −1.049E+02 | X10 | −1.403E+01 |
| | | | | X8Y2 | −7.048E+02 | X6Y4 | −1.211E+03 | X4Y6 | −1.684E+03 |
| | | | | X2Y8 | 3.103E+02 | Y10 | −4.478E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 5.574E−02 | X2 | 2.158E+00 | Y2 | 1.648E+00 |
| | | | | X2Y | −1.203E+00 | Y3 | −2.046E−01 | X4 | −2.088E+00 |
| | | | | X2Y2 | −1.132E+00 | Y4 | 1.944E−01 | X4Y | 2.493E+00 |
| | | | | X2Y3 | 3.847E+00 | Y3 | 5.222E+00 | X6 | 3.117E+01 |
| | | | | X4Y2 | 8.541E+01 | X2Y4 | 4.885E+01 | Y8 | 2.257E+01 |
| | | | | X6Y | −7.144E+00 | X4Y3 | 2.698E+01 | X2Y5 | −8.971E+01 |
| | | | | Y7 | 5.812E+01 | X8 | −2.204E+02 | X6Y2 | −6.430E+02 |
| | | | | X4Y4 | −1.079E+03 | X2Y6 | −3.743E+02 | Y8 | −3.375E+01 |
| | | | | X8Y | −5.118E+00 | X6Y3 | 8.469E+01 | X4Y5 | −1.675E+02 |
| | | | | X2Y7 | 9.458E+02 | Y9 | −1.604E+03 | X10 | 9.881E+02 |
| | | | | X8Y2 | 2.186E+03 | X6Y4 | 7.717E+03 | X4Y6 | 4.978E+03 |
| | | | | X2Y8 | 3.309E+03 | Y10 | −4.094E+03 | | |

| H1 90 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 0.9823362 | 0.128 | 0.000 | X2 | 1.932E−01 | Y2 | 2.563E−01 | X2Y | 9.488E−02 |
| 2 | 1E+18 | 0.305 | 0.034 | Y3 | 2.212E−02 | X4 | 1.847E−01 | X2Y2 | 5.242E−01 |
| 3 | 1E+18 | 0.049 | 0.034 | Y4 | 2.727E−01 | X4Y | 1.371E−01 | X2Y3 | −1.311E−01 |
| 4 | 0.8918276 | 0.841 | 0.057 | Y5 | −7.087E−02 | X6 | 4.301E−01 | X4Y2 | 2.538E+00 |
| 5 | 0.8048913 | 0.059 | 0.676 | X2Y4 | 2.083E+00 | Y6 | 4.982E−01 | X6Y | 1.377E+00 |
| 6 | 1E+18 | 0.300 | 0.676 | X4Y3 | 3.983E+00 | X2Y5 | 2.047E+00 | Y7 | 2.015E−01 |
| 7 | 1E+16 | 0.056 | 0.676 | X8 | −5.748E−01 | X6Y2 | −1.311E+01 | X4Y4 | −7.419E+00 |
| 8 | −0.413128 | 0.143 | 0.922 | X2Y6 | 3.744E+00 | Y8 | 1.734E+00 | X8Y | 5.091E−01 |
| 9 | 1E+18 | 0.500 | 1.219 | X6Y3 | −1.525E+01 | X4Y5 | −1.584E+01 | X2Y7 | −9.937E+00 |
| 10 | 1E+18 | 0.050 | 1.219 | Y9 | −1.532E+00 | X10 | 2.810E+00 | X8Y2 | 6.679E+01 |
| | | | | X6Y4 | 1.326E+02 | X4Y6 | 4.839E+00 | X2Y8 | −4.606E+00 |
| | | | | Y10 | 6.495E−01 | | | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −1.950E−02 | X2 | −2.305E−01 | Y2 | −1.053E−01 |
| | | | | X2Y | 3.589E−01 | Y3 | 2.922E−01 | X4 | 1.072E−01 |
| | | | | X2Y2 | 1.103E+00 | Y4 | 5.410E−01 | X4Y | 8.136E−01 |
| | | | | X2Y3 | 1.322E+00 | Y5 | 9.805E−01 | X6 | 8.871E−01 |
| | | | | X4Y2 | 1.827E+00 | X2Y4 | 4.066E+00 | Y6 | 1.921E+00 |
| | | | | X6Y | 8.429E−01 | X4Y3 | 2.176E+01 | X2Y5 | −2.210E+01 |
| | | | | Y7 | −1.478E+01 | X8 | −1.113E+01 | X6Y2 | 3.486E+01 |
| | | | | X4Y4 | −6.924E+01 | X2Y6 | 7.951E+01 | Y8 | 2.967E+01 |
| | | | | X8Y | 7.006E+01 | X6Y3 | −2.128E+02 | X4Y5 | 3.376E+02 |
| | | | | X2Y7 | 1.913E+02 | Y9 | 3.655E+01 | X10 | 4.297E+02 |
| | | | | X8Y2 | −4.878E+01 | X6Y4 | 1.265E+03 | X4Y6 | 2.682E+02 |
| | | | | X2Y8 | −2.118E+02 | Y10 | 1.285E+01 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | 1.034E−02 | X2 | −3.324E−01 | Y2 | −4.853E−01 |
| | | | | X2Y | −1.152E+00 | Y3 | −6.975E−01 | X4 | −1.899E+00 |
| | | | | X2Y2 | −1.363E+00 | Y4 | −6.362E−01 | X4Y | −7.140E−02 |
| | | | | X2Y3 | 3.340E−01 | Y5 | 3.086E+00 | X6 | 9.224E+00 |
| | | | | X4Y2 | 8.018E+00 | X2Y4 | 1.627E+01 | Y6 | 1.312E+01 |
| | | | | X6Y | −9.342E−01 | X4Y3 | 3.250E+01 | X2Y5 | 4.167E+01 |
| | | | | Y7 | −3.490E+00 | X8 | −1.403E+02 | X6Y2 | −1.948E−02 |
| | | | | X4Y4 | −6.501E+01 | X2Y6 | −1.541E+02 | Y8 | −1.114E+02 |
| | | | | X8Y | 2.759E+01 | X6Y3 | 8.421E+01 | X4Y5 | −1.763E+02 |
| | | | | X2Y7 | −1.617E+02 | Y9 | −2.931E+01 | X10 | 3.833E+01 |
| | | | | X8Y2 | 5.046E+02 | X6Y4 | 1.798E+03 | X4Y6 | 6.052E+02 |
| | | | | X2Y8 | 4.976E+02 | Y10 | 3.741E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 5.821E−02 | X2 | 1.944E+00 | Y2 | 1.232E+00 |
| | | | | X2Y | −2.244E+00 | Y3 | −9.106E−01 | X4 | −1.092E+00 |
| | | | | X2Y2 | 3.940E+00 | Y4 | 3.141E+00 | X4Y | 9.460E+00 |
| | | | | X2Y3 | −1.676E+00 | Y5 | 3.716E+00 | X6 | 4.977E+01 |
| | | | | X4Y2 | 7.534E+01 | X2Y4 | 8.541E+01 | Y6 | 2.110E+01 |
| | | | | X6Y | −2.495E+02 | X4Y3 | −1.122E+02 | X2Y5 | 3.935E+01 |
| | | | | Y7 | −7.803E+00 | X8 | −3.355E+02 | X6Y2 | −3.878E+02 |
| | | | | X4Y4 | −1.323E+03 | X2Y6 | −7.011E+02 | Y8 | −2.161E+02 |
| | | | | X8Y | 1.907E+03 | X6Y3 | 2.214E+03 | X4Y5 | 1.624E+02 |
| | | | | X2Y7 | −2.378E+02 | Y9 | −1.973E+02 | X10 | −3.812E+02 |
| | | | | X8Y2 | −1.305E+03 | X6Y4 | 1.028E+04 | X4Y6 | 1.207E+04 |
| | | | | X2Y8 | 4.050E+03 | Y10 | 6.586E+02 | | |

[symbol]

indicates data missing or illegible when filed

TABLE 2C

| H2 90 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 1.1651657 | 0.229 | 0.000 | Y | −4.850E−02 | X2 | 3.398E−01 | Y2 | 3.153E−01 |
| 2 | 1E+18 | 0.305 | 0.027 | X2Y | −3.443E−02 | Y3 | −1.523E−02 | X4 | 3.461E−01 |
| 3 | 1E+18 | 0.050 | 0.027 | X2Y2 | 7.164E−01 | Y4 | 2.954E−01 | X4Y | −8.308E−02 |
| 4 | 0.7905029 | 0.801 | 0.051 | X2Y3 | −3.503E−01 | Y5 | −5.021E−02 | X6 | 2.873E−01 |
| 5 | 0.7593585 | 0.099 | 0.430 | X4Y2 | 8.436E−01 | X2Y4 | 9.410E−01 | Y6 | 4.425E−01 |
| 6 | 1E+18 | 0.300 | 0.430 | X6Y | 2.398E−01 | X4Y3 | 1.708E+00 | X2Y5 | 1.711E+00 |
| 7 | 1E+18 | 0.056 | 0.430 | Y7 | −6.189E−02 | X8 | 2.280E+00 | X6Y2 | 7.240E+00 |
| 8 | −0.422505 | 0.144 | 0.606 | X4Y4 | 1.079E+01 | X2Y6 | 5.784E+00 | Y8 | −2.796E−01 |
| 9 | 1E+18 | 0.500 | 0.748 | X8Y | −5.278E−01 | X6Y3 | −6.341E+00 | X4Y5 | −1.171E+01 |
| 10 | 1E+18 | 0.050 | 0.748 | X2Y7 | −8.037E+00 | Y9 | 8.197E−01 | X10 | −1.105E+00 |
| | | | | X8Y2 | −2.612E+00 | X6Y4 | −8.536E+00 | X4Y6 | −8.837E+00 |
| | | | | X2Y8 | −7.700E+00 | Y10 | 1.520E+00 | | |
| | | | | FREE | | | | | |
| | | | | SPHERICAL | | | | | |
| | | | | SURFACE | FOURTH | | | | |
| | | | | COEFFICIENT | FACE | | | | |
| | | | | X2 | −1.465E−01 | Y2 | −2.177E−01 | X2Y | 1.452E−01 |
| | | | | Y3 | 2.174E−01 | X4 | 2.979E−01 | X2Y2 | 9.498E−01 |
| | | | | Y4 | 3.609E−01 | X4Y | 1.018E+00 | X2Y3 | 1.705E+00 |
| | | | | Y5 | 9.673E−01 | X6 | 1.769E+00 | X4Y2 | 4.184E+00 |
| | | | | X2Y4 | 1.091E+00 | Y6 | −1.382E+00 | X6Y | −3.207E+00 |
| | | | | X4Y3 | −4.575E+00 | X2Y5 | −8.307E+00 | Y7 | −1.162E+00 |
| | | | | X8 | 1.594E−01 | X6Y2 | −1.358E+01 | X4Y4 | −2.678E+01 |
| | | | | X2Y6 | 2.643E+01 | Y8 | 1.356E+01 | X8Y | 6.085E+01 |
| | | | | X6Y3 | 1.129E+02 | X4Y5 | 1.190E+02 | X2Y7 | 1.273E+02 |
| | | | | Y9 | 1.234E+01 | X10 | 3.918E+01 | X8Y2 | 2.726E+02 |
| | | | | X8Y4 | 8.781E+02 | X4Y6 | 8.510E+02 | X2Y8 | 4.435E+01 |
| | | | | Y10 | 2.158E+01 | | | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | 6.221E−02 | X2 | −2.628E−01 | Y2 | −3.569E−01 |
| | | | | X2Y | −6.184E−01 | Y3 | −2.322E−01 | X4 | −1.612E+00 |
| | | | | X2Y2 | −1.526E+00 | Y4 | −1.386E+00 | X4Y | 7.052E−01 |
| | | | | X2Y3 | 3.916E+00 | Y5 | −1.074E+00 | X5 | 2.025E+00 |
| | | | | X4Y2 | −2.989E−01 | X2Y4 | 3.687E+00 | Y6 | 1.385E+01 |
| | | | | X6Y | −2.458E−01 | X4Y3 | −2.134E+01 | X2Y5 | −2.926E+01 |
| | | | | Y7 | 3.019E+01 | X8 | −2.211E+01 | X6Y2 | −7.778E+01 |
| | | | | X4Y4 | 7.705E+01 | X2Y6 | −2.956E+01 | Y8 | −1.306E+02 |
| | | | | X8Y | 1.249E+02 | X6Y3 | 1.690E+02 | X4Y5 | 2.116E+02 |
| | | | | X2Y7 | 1.772E+02 | Y9 | −1.230E+02 | X10 | −6.202E+00 |
| | | | | X8Y2 | 1.835E+02 | X6Y4 | −3.325E+02 | X4Y6 | −2.488E+02 |
| | | | | X2Y8 | −5.694E+01 | Y10 | 4.235E+02 | | |
| | | | | FREE | | | | | |
| | | | | SPHERICAL | | | | | |
| | | | | SURFACE | EIGHTH | | | | |
| | | | | COEFFICIENT | FACE | | | | |

| | | | | | | |
|---|---|---|---|---|---|---|
| Y: | Y: | 1.412E−01 | X2: | 2.047E+00 | Y2: | 1.671E+00 |
| X2 [symbol] | X2Y: | −1.624E+00 | Y3: | −1.175E+00 | X4: | −1.754E+00 |
| X2 [symbol] | XZY2: | 3.538E+00 | Y4: | 6.508E−01 | X4Y: | −1.012E+00 |
| X2 [symbol] | X2Y3: | 6.616E+00 | Y5: | 7.615E+00 | X6: | 3.736E+01 |
| X4 [symbol] | X4Y2: | 7.537E+01 | X2Y4: | 3.142E+01 | Y6: | 3.020E+01 |
| X6 [symbol] | X6Y: | −6.621E+00 | X4Y3: | 1.584E+01 | X2Y5: | −9.595E+01 |
| Y7 [symbol] | Y7: | −4.217E+01 | X8: | −2.071E+02 | X6Y2: | −1.046E+03 |
| X4 [symbol] | X4Y4: | −6.902E+02 | X2Y6: | −2.761E+02 | Y8: | −2.014E+02 |
| X8 [symbol] | X8Y: | 1.875E+02 | X6Y3: | 5.745E+02 | X4Y5: | −9.503E+01 |
| X2 [symbol] | X2Y7: | 5.976E+02 | Y9: | −2.295E+01 | X10: | 7.177E+02 |
| X8 [symbol] | X8Y2: | 4.223E+03 | X6Y4: | 7.642E+03 | X4Y6: | 7.172E+03 |
| X2 [symbol] | X2Y8: | 2.643E+03 | XY9: | 1.168E−03 | Y10: | 3.982E+02 |

[symbol]

indicates data missing or illegible when filed

TABLE 2D

| VD 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | −4.264121 | 0.253 | 0.000 | 0.000 | X | −7.687E−03 | Y | −7.987E−02 | X2 | 7.404E−01 |
| 2 | inf | 0.305 | 0.058 | 0.066 | XY | 7.670E−03 | Y2 | 7.511E−01 | X3 | 1.163E−03 |
| 3 | inf | 0.050 | 0.058 | 0.066 | X2Y | 1.032E−01 | XY2 | 2.103E−02 | Y3 | −1.158E−02 |
| 4 | 0.3876792 | 0.823 | 0.116 | 0.136 | X4 | 2.624E−01 | X3Y | −1.112E−01 | X2Y2 | 3.717E−01 |
| 5 | 0.3621693 | 0.077 | 0.448 | 0.492 | XY3 | 1.015E−02 | Y4 | 2.256E−01 | X6 | 9.107E−03 |
| 6 | inf | 0.300 | 0.448 | 0.492 | X4Y | 1.787E−01 | X3Y2 | −2.693E−02 | X2Y3 | 1.776E−01 |
| 7 | inf | 0.050 | 0.448 | 0.492 | XY4 | −8.743E−02 | Y5 | 2.290E−02 | X6 | 3.745E−01 |
| 8 | −0.392227 | 0.150 | 0.564 | 0.686 | X5Y | −5.506E−02 | X4Y2 | 5.975E−01 | X3Y3 | −7.681E−02 |
| 9 | inf | 0.500 | 0.748 | 0.881 | X2Y4 | 1.341E−01 | XY5 | 1.424E−01 | Y6 | −2.809E−02 |
| 10 | inf | 0.050 | 0.748 | 0.881 | X7 | −3.270E−02 | X6Y | 2.978E−01 | X5Y2 | 5.403E−01 |
| | | | | | X4Y3 | 5.553E−01 | X3Y4 | 6.474E−01 | X2Y5 | 6.755E−01 |
| | | | | | XY6 | 3.658E−01 | Y7 | 2.001E−01 | X8 | 1.719E−01 |
| | | | | | X7Y | −1.064E+00 | X6Y2 | −1.755E−03 | X5Y3 | −1.412E+00 |
| | | | | | X4Y4 | 1.661E+00 | X3Y [symbol] | −2.283E+00 | X2Y6 | 1.680E+00 |
| | | | | | XY7 | −6.841E−01 | Y8 | 5.300E−01 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | 6.420E−03 | Y | −2.456E−02 | X2 | −9.658E−01 |
| | | | | | XY | 4.768E−02 | Y2 | −9.549E−01 | X3 | 2.367E−01 |
| | | | | | X2Y | 8.135E−01 | XY2 | 2.831E−01 | Y3 | 2.502E−01 |
| | | | | | X4 | −1.562E+00 | X3Y | 2.809E−01 | X2Y2 | −3.492E+00 |
| | | | | | XY3 | 5.912E−01 | Y4 | −1.879E+00 | X5 | 4.549E−01 |
| | | | | | X4Y | 8.407E−01 | X3Y2 | 6.002E−01 | X2Y3 | 1.323E+00 |
| | | | | | XY4 | 3.631E−01 | Y5 | 4.537E−01 | X6 | −2.217E+00 |
| | | | | | X5Y | 7.387E−01 | X4Y2 | −9.622E+00 | X3Y3 | −1.563E−00 |
| | | | | | X2Y4 | −1.130E+01 | XY5 | −7.928E−01 | Y6 | −3.103E+00 |
| | | | | | X7 | 6.545E+00 | X6Y | 1.203E+01 | X5Y2 | 1.688E+01 |
| | | | | | X4Y3 | 1.740E+01 | X3Y4 | 1.432E+01 | X2Y5 | 1.268E+01 |
| | | | | | XY6 | 5.076E+00 | Y7 | 2.942E+00 | X8 | −6.451E+01 |
| | | | | | X7Y | 1.204E+01 | X6Y2 | −2.629E+02 | X5Y3 | 6.566E+01 |
| | | | | | X4Y4 | −3.899E+02 | X3Y5 | 5.762E+01 | X2Y6 | −2.745E+02 |
| | | | | | XY7 | 2.048E+01 | Y [symbol] | −7.743E+01 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | −8.564E−02 | Y | −5.357E−02 | X2 | −1.483E+00 |
| | | | | | XY | −3.206E−01 | Y2 | −1.055E+00 | X3 | −1.189E+00 |
| | | | | | X2Y | 3.814E−01 | XY2 | −7.183E−01 | Y3 | −4.813E−01 |
| | | | | | X4 | −2.094E+00 | X3Y | 2.110E+00 | X2Y2 | −3.583E+00 |
| | | | | | XY3 | 2.063E+00 | Y4 | −2.598E+00 | X5 | −5.791E+00 |
| | | | | | X4Y | 5.391E−01 | X3Y2 | 1.455E+00 | X2Y3 | 6.809E+00 |
| | | | | | XY4 | −1.318E+00 | Y5 | 4.070E−01 | X6 | −3.597E+01 |
| | | | | | X5Y | −3.170E+01 | X4Y2 | −1.023E+02 | X3Y3 | −1.006E+01 |
| | | | | | X2Y4 | −1.044E+02 | XY5 | 2.638E+00 | Y6 | −1.637E+01 |
| | | | | | X7 | 1.129E+02 | X6Y | 1.154E+02 | X5Y2 | −4.378E+01 |
| | | | | | X4Y3 | 3.578E+01 | X3Y4 | −3.111E+01 | X2Y5 | −2.617E+01 |
| | | | | | XY6 | 2.029E+01 | Y7 | 1.124E+01 | X8 | 5.787E+02 |
| | | | | | X7Y | 6.146E+02 | X6Y2 | 1.430E+03 | X5Y3 | 6.847E+02 |
| | | | | | X4Y4 | 1.992E+03 | X3Y5 | 1.539E+02 | X2Y6 | 1.276E+03 |
| | | | | | XY7 | −4.510E+01 | Y8 | 9.786E+01 | X9 | −2.612E+02 |
| | | | | | X8Y | −6.187E+02 | X7Y2 | 7.322E+02 | X6Y3 | −5.945E+02 |
| | | | | | X5Y4 | 8.281E+02 | X4Y5 | 8.908E+01 | X3Y6 | 1.440E+01 |
| | | | | | X2Y7 | 3.023E+02 | XY8 | 6.293E−01 | Y9 | −1.332E+02 |
| | | | | | X10 | −2.662E+03 | X9Y | −7.023E+03 | X8Y2 | −1.113E+04 |
| | | | | | X7Y3 | −5.988E+03 | X6Y4 | −1.910E+04 | X5Y5 | −4.536E+03 |
| | | | | | X4Y6 | −2.051E+04 | X3Y7 | 2.666E+02 | X2Y8 | −9.505E+03 |
| | | | | | XY9 | 4.179E+02 | Y10 | −1.322E+03 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | 2.063E−02 | Y | −6.580E−02 | X2 | 1.197E+00 |
| | | | | | XY | −6.599E−01 | Y2 | 1.925E+00 | X3 | −1.021E+00 |
| | | | | | X2Y | 3.712E−01 | XY2 | −5.581E−01 | Y3 | −7.358E−01 |
| | | | | | X4 | 4.481E−01 | X3Y | 1.084E+00 | X2Y2 | 2.380E+00 |
| | | | | | XY3 | 4.838E+00 | Y4 | 6.962E−01 | X5 | −5.123E+00 |
| | | | | | X4Y | −1.511E+00 | X3Y2 | −1.919E−01 | X2Y3 | 3.229E+00 |
| | | | | | XY4 | −8.853E+00 | Y5 | −7.858E−01 | X6 | 5.294E+01 |
| | | | | | X5Y | −3.492E+01 | X4Y2 | 9.887E+01 | X3Y3 | −2.661E+01 |
| | | | | | X2Y4 | 7.829E+01 | XY5 | −3.656E+01 | Y6 | 2.663E+01 |
| | | | | | X7 | 1.237E+02 | X6Y | 2.109E+01 | X5Y2 | −1.502E+02 |
| | | | | | X4Y3 | −2.250E+01 | X3Y4 | 7.840E+01 | X2Y5 | 1.010E+01 |
| | | | | | XY6 | 3.002E+01 | Y7 | −1.023E−01 | X8 | −2.121E+02 |
| | | | | | X7Y | 8.871E+02 | X6Y2 | −1.735E+03 | X5Y3 | 2.624E+02 |
| | | | | | X4Y4 | −1.414E+03 | X3Y5 | 3.326E+02 | X2Y6 | −9.103E+02 |
| | | | | | XY7 | 5.345E+02 | Y8 | 1.846E+00 | X9 | −9.386E+02 |
| | | | | | X [symbol] Y | 2.535E+02 | X7Y2 | 1.829E+03 | X6Y3 | 1.535E+03 |
| | | | | | X5Y4 | 1.203E+02 | X4Y5 | −3.566E+02 | X3Y6 | −4.761E+02 |
| | | | | | X2Y7 | 4.149E+01 | XY8 | 2.354E+02 | Y9 | 1.964E+02 |
| | | | | | X10 | 1.084E+03 | X9Y | −7.636E+03 | X8Y2 | 1.818E+04 |
| | | | | | X7Y3 | 9.360E+02 | X6Y4 | 1.685E+04 | X5Y5 | −1.185E+03 |
| | | | | | X4Y6 | 1.604E+04 | X3Y7 | −1.610E+03 | X2Y8 | 6.938E+03 |
| | | | | | XY9 | −3.039E+03 | Y10 | −1.202E+03 | | |

[symbol]

indicates data missing or illegible when filed

TABLE 2E

| HD 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | 1.2608227 | 0.110 | 0.000 | 0.000 | X: | −1.032E−01 | Y: | −7.220E−02 | X2: | 3.456E−01 |
| 2 | inf | 0.305 | 0.065 | 0.053 | XY: | 3.212E−02 | Y2: | 4.208E−01 | X3: | −1.306E−01 |
| 3 | inf | 0.050 | 0.085 | 0.053 | X2Y: | 7.878E−02 | XY2: | −2.061E−01 | Y3: | −1.161E−01 |
| 4 | 0.3461376 | 0.823 | 0.120 | 0.112 | X4: | 3.586E−01 | X3Y: | 6.920E−02 | X2Y2: | 5.123E−01 |
| 5 | 0.4114151 | 0.077 | 0.707 | 0.368 | XY3: | 4.463E−02 | Y4: | 4.858E−01 | X5: | −3.510E−01 |
| 6 | inf | 0.300 | 0.707 | 0.368 | X4Y: | 8.739E−02 | X3Y2: | −9.780E−01 | X2Y3: | 1.606E−02 |
| 7 | inf | 0.050 | 0.707 | 0.368 | XY4: | −5.955E−01 | Y5: | −2.240E−01 | X6: | 8.161E−01 |
| 8 | −0.403851 | 0.150 | 0.931 | 0.449 | X5Y: | −2.599E−01 | X4Y2: | 2.657E+00 | X3Y3: | −8.253E−02 |
| 9 | inf | 0.500 | 1.269 | 0.571 | X2Y4: | 2.575E+00 | XY5: | 6.799E−01 | Y6: | 1.368E+00 |
| 10 | inf | 0.050 | 1.269 | 0.571 | X7: | 1.765E+00 | X6Y: | 2.576E+00 | X5Y2: | 3.911E+00 |
| | | | | | X4Y3: | 5.592E+00 | X3Y4: | 3.363E+00 | X2Y5: | −5.027E−01 |
| | | | | | XY8: | 5.651E−02 | Y7: | −1.606E+00 | X8: | −3.810E+00 |
| | | | | | X7Y: | 2.328E+00 | X6Y2: | −3.126E+01 | X5Y3: | 1.486E+01 |
| | | | | | X4Y4: | −4.195E+01 | X3Y5: | 1.258E+01 | X2Y6: | −1.848E+01 |
| | | | | | XY7: | −2.062E+00 | Y8: | −5.657E+00 | X9: | −1.573E+01 |
| | | | | | X8Y: | −2.546E+00 | X7Y2: | −4.593E+01 | X6Y3: | −1.475E+01 |
| | | | | | X5Y4: | −6.875E+01 | X4Y5: | −1.340E+01 | X3Y6: | −4.468E+01 |
| | | | | | X2Y7: | 3.129E+01 | XY8: | −7.058E+00 | Y9: | 2.329E+00 |
| | | | | | X10: | 2.988E+01 | X9Y: | −2.309E+01 | X3Y2: | 2.775E+02 |
| | | | | | X7Y3: | −1.620E+02 | X6Y4: | 4.826E+02 | X5Y5: | −2.131E+02 |
| | | | | | X4Y6: | 4.351E+02 | X3Y7: | −1.222E+02 | X2Y8: | 1.108E+02 |
| | | | | | XY9: | 1.336E+01 | Y10: | 4.379E+01 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | Y: | −5.167E−02 | X2: | −1.021E+00 | XY: | 9.057E−02 |
| | | | | | Y2: | −8.491E−01 | X3: | 7.206E−02 | X2Y: | 7.312E−01 |
| | | | | | XY2: | 4.391E−02 | Y3: | 3.174E−01 | X4: | −2.415E+00 |
| | | | | | X3Y: | 5.819E−01 | X2Y2: | −4.878E+00 | XY3: | 1.918E−01 |
| | | | | | Y4: | −1.987E+00 | X5: | 6.905E−01 | X4Y: | 2.152E+00 |
| | | | | | X3Y2: | −2.667E−01 | X2Y3: | 2.476E+00 | XY4: | −5.133E−01 |
| | | | | | Y5: | 2.097E−01 | X6: | −1.237E+01 | X5Y: | 3.991E+00 |
| | | | | | X4Y2: | −4.700E+01 | X3Y3: | 1.905E+00 | X2Y4: | −4.810E+01 |
| | | | | | XY5: | 1.334E+00 | Y6: | −1.308E+01 | X7: | −1.640E+01 |
| | | | | | X6Y: | −1.195E+01 | X5Y2: | 6.418E+00 | X4Y3: | −9.505E−01 |
| | | | | | X3Y4: | −1.205E+01 | X2Y5: | 4.589E+01 | XY6: | −4.522E+00 |
| | | | | | Y7: | 1.501E+01 | X8: | −4.384E+01 | X7Y: | −1.256E+02 |
| | | | | | X6Y2: | 1.924E+02 | X5Y3: | −1.097E+02 | X4Y4 | 4.079E+02 |
| | | | | | X3Y5: | −3.213E+01 | X2Y6: | 1.056E+02 | XY7: | −3.377E+01 |
| | | | | | Y8: | 1.732E+01 | X9: | 2.268E+02 | X8Y: | 2.876E+02 |
| | | | | | X7Y2: | 8.128E+01 | X6Y3: | 7.380E+02 | X5Y4: | 2.786E+02 |
| | | | | | X4Y5: | −1.101E+02 | X3Y6: | 9.655E+02 | X2Y7: | −4.602E+02 |
| | | | | | XY8: | 4.699E+01 | Y9: | −1.380E+02 | X10: | −4.875E+02 |
| | | | | | X9Y: | 1.581E+03 | X8Y2: | −6.853E+03 | X7Y3: | 3.303E+03 |
| | | | | | X6Y4: | −1.555E+04 | X5Y5: | 5.934E+02 | X4Y6: | −1.361E+04 |
| | | | | | X3Y7: | −1.852E+03 | X2Y8: | −4.937E+03 | XY9: | 4.632E+02 |
| | | | | | Y10: | −9.424E+02 | | | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | Y: | −1.200E−01 | X2: | −8.600E−01 | XY: | −2.464E−01 |
| | | | | | Y2: | −1.016E+00 | X3: | −5.029E−01 | X2Y: | −5.547E−01 |
| | | | | | XY2: | 8.931E−02 | Y3: | −4.488E−01 | X4: | −3.021E+00 |
| | | | | | X3Y: | 1.575E+00 | X2Y2: | −5.192E+00 | XY3: | 8.905E−01 |
| | | | | | Y4: | −1.833E+00 | X5: | −9.461E−01 | X4Y: | 2.505E+00 |
| | | | | | X3Y2: | 1.731E+00 | X2Y3: | 4.064E+00 | XY4: | 2.776E+00 |
| | | | | | Y5: | 3.934E+00 | X6: | 1.122E+01 | X5Y: | 5.850E+00 |
| | | | | | X4Y2: | −1.859E+01 | X3Y3: | −2.142E−01 | X2Y4: | −1.644E+01 |
| | | | | | XY5: | −7.014E+00 | Y6: | 2.311E+00 | X7: | 3.066E+01 |
| | | | | | X6Y: | −1.199E+01 | X5Y2: | −7.495E+00 | X4Y3: | 1.4 [symbol] 1E+01 |
| | | | | | X3Y4: | −5.195E+01 | X2Y5: | −3.333E+00 | XY6: | −3.921E+01 |
| | | | | | Y7: | −2.054E+01 | X8: | −1.924E+02 | X7Y: | −9.970E+01 |
| | | | | | X6Y2: | 1.319E+02 | X5Y3: | 8.209E+00 | X4Y4: | 1.792E+02 |
| | | | | | X3Y5: | 1.405E+02 | X2Y6: | −6.394E+01 | XY7: | 9.714E+01 |
| | | | | | Y5: | −8.167E+01 | X9: | −3.282E+02 | X8Y: | 3.090E+02 |
| | | | | | X7Y2: | −2.865E+02 | X6Y3: | 1.059E+02 | X5Y4: | 3.461E+02 |
| | | | | | X4Y5: | −8.080E−01 | X3Y6: | 3.611E+02 | X2Y7: | −1.460E+01 |
| | | | | | XY8: | 2.089E+02 | Y9: | −3.903E+01 | X10: | 1.417E+02 |
| | | | | | X9Y: | 8.619E+02 | X [symbol] Y2: | −3.193E+03 | X7Y3: | 9.731E+02 |
| | | | | | X6Y4: | −5.009E+03 | X5Y5: | −1.530E+03 | X4Y6: | −3.970E+03 |
| | | | | | X3Y7: | −7.024E+02 | X2Y8: | −1.376E+03 | XY9: | −5.756E+02 |
| | | | | | V10: | 6.119E+01 | | | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X2: | 2.100E+00 | XY: | −6.648E−01 | Y2: | 1.559E+00 |
| | | | | | X3: | −6.817E−01 | X2Y: | −1.793E+00 | XY2: | 6.091E−01 |
| | | | | | Y3: | −7.332E−01 | X4: | 3.617E−01 | X3Y: | 3.528E+00 |
| | | | | | X2Y2: | 4.384E−01 | XY3: | 9.834E−01 | Y4: | 1.798E+00 |
| | | | | | X5: | −8.057E+00 | X4Y: | 5.733E+00 | X3Y2: | −1.789E+00 |
| | | | | | X2Y3: | 8.020E+00 | XY4: | −1.584E+00 | Y5: | 4.678E+00 |
| | | | | | X6: | 5.037E+01 | X5Y: | −2.994E+01 | X4Y2: | 7.573E+01 |
| | | | | | X3Y3: | −2.282E+01 | X2Y4: | 5.603E+01 | XY5: | −5.060E+00 |
| | | | | | Y6: | 2.499E+01 | X7: | 8.081E+01 | X6Y: | −1.345E+02 |
| | | | | | X5Y2: | −4.184E+01 | X4Y3: | 4.541E+01 | X3Y4: | 2.534E+01 |
| | | | | | X2Y5: | −7.698E+01 | XY6: | 2.684E+01 | Y7: | 4.323E+01 |
| | | | | | X8: | −1.892E+02 | X7Y: | 6.008E+02 | X6Y2: | −7.306E+02 |
| | | | | | X5Y3: | 1.707E+02 | X4Y4: | −1.069E+03 | X3Y5: | 3.025E+02 |
| | | | | | X2Y6: | −6.698E+02 | XY7: | 8.294E+01 | Y8: | −2.100E+02 |
| | | | | | X9: | −7.648E+02 | X8Y: | 1.682E+03 | X7Y2: | 5.882E+02 |
| | | | | | X6Y3: | −5.092E+02 | X5Y4: | 2.607E+02 | X4Y5: | 2.322E+02 |
| | | | | | X3Y6: | −4.639E+02 | X2Y7: | 5.813E+02 | XY8: | −1.278E+02 |
| | | | | | Y9: | −9.033E+02 | X10: | −8.080E+02 | X9Y: | −6.045E+03 |
| | | | | | X8Y2: | 3.599E+03 | X7Y3: | 1.643E+03 | X6Y4: | 1.079E+04 |
| | | | | | X5Y5: | −3.405E+03 | X4Y6: | 1.018E+04 | X3Y7: | −2.451E+01 |
| | | | | | X2Y8: | 5.419E+03 | XY9: | −1.169E+03 | Y10: | 2.954E+02 |

[symbol]

indicates data missing or illegible when filed

TABLE 2F

| D1 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | 1.2358278 | 0.211 | 0.000 | 0.000 | X | −9.186E−02 | Y | 2.308E−02 | X2 | 1.481E−01 |
| 2 | 1E+18 | 0.305 | 0.048 | 0.077 | XY | 5.171E−05 | Y2 | 2.354E−01 | X3 | −3.973E−05 |
| 3 | 1E+18 | 0.050 | 0.046 | 0.077 | X2Y | 2.215E−02 | XY2 | 4.181E−04 | Y3 | 8.330E−03 |
| 4 | 0.3234832 | 0.851 | 0.099 | 0.159 | X4 | 1.059E−01 | X3Y | 7.962E−04 | X2Y2 | 5.188E−01 |
| 5 | 0.4950896 | 0.050 | 0.598 | 0.709 | XY3 | 3.031E−03 | Y4 | 2.135E−01 | X5 | −1.426E−04 |
| 6 | 1E+18 | 0.300 | 0.598 | 0.709 | X4Y | −8.646E−02 | X3Y2 | 3.051E−03 | X2Y3 | −6.310E−02 |
| 7 | 1E+18 | 0.098 | 0.598 | 0.709 | XY4 | −9.572E−03 | Y5 | 1.490E−01 | X6 | 4.921E−01 |
| 8 | −0.395532 | 0.101 | 0.886 | 0.711 | X5Y | 2.246E−02 | X4Y2 | 2.064E+00 | X3Y3 | 1.799E−02 |
| 9 | 1E+18 | 0.500 | 1.208 | 0.892 | X2Y4 | 2.224E+00 | XY5 | −3.616E−02 | Y6 | 5.927E−01 |
| 10 | 1E+18 | 0.050 | 1.208 | 0.892 | X7 | 6.679E−04 | X6Y | 7.171E−01 | X5Y2 | −3.800E−02 |
| | | | | | X4Y3 | −7.353E−01 | X3Y4 | 1.386E−01 | X2Y5 | −1.834E+00 |
| | | | | | XY6 | 4.722E−02 | Y7 | −4.578E−01 | X8 | −3.851E+00 |
| | | | | | X7Y | −3.278E−01 | X6Y2 | −1.128E+01 | X5Y3 | −5.286E−03 |
| | | | | | X4Y4 | −1.464E+01 | X3Y5 | −1.031E+00 | X2Y6 | −1.340E+01 |
| | | | | | XY7 | 5.227E−02 | Y8 | −2.628E+00 | X9 | 3.097E−02 |
| | | | | | X8Y | 1.792E+01 | X7Y2 | −1.206E+00 | X6Y3 | 5.553E+01 |
| | | | | | X5Y4 | −1.963E+00 | X4Y5 | 4.062E+01 | X3Y6 | 4.309E+00 |
| | | | | | X2Y7 | −9.256E+00 | XY8 | 6.265E−01 | Y9 | 3.247E−01 |
| | | | | | X10 | 1.153E+01 | X9Y | 1.005E+02 | X8Y2 | −2.244E+03 |
| | | | | | X7Y3 | −2.786E+03 | X6Y4 | −3.212E+03 | X5Y5 | 3.931E+03 |
| | | | | | X4Y6 | −1.136E+03 | X3Y7 | −3.425E+03 | X2Y8 | −1.015E+03 |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | 1.400E−02 | Y | −3.282E−02 | X2 | −1.277E+00 |
| | | | | | XY | 6.908E−02 | Y2 | −1.145E+00 | X3 | 2.150E−01 |
| | | | | | X2Y | 1.974E−02 | XY2 | 3.612E−01 | Y3 | 2.602E−01 |
| | | | | | X4 | −4.229E+00 | X3Y | 2.279E−01 | X2Y2 | −6.391E+00 |
| | | | | | XY3 | 3.388E−01 | Y4 | −2.953E+00 | X5 | 1.908E−01 |
| | | | | | X4Y | 1.139E+01 | X3Y2 | 2.113E+00 | X2Y3 | −7.453E−01 |
| | | | | | XY4 | −3.007E−01 | Y5 | −2.358E+00 | X6 | −4.041E−01 |
| | | | | | X5Y | −3.619E+00 | X4Y2 | −4.692E+01 | X3Y3 | 3.629E+00 |
| | | | | | X2Y4 | −2.733E+01 | XY5 | 3.651E+00 | Y6 | −1.741E+01 |
| | | | | | X7 | −3.143E−03 | X6Y | −3.217E+02 | X5Y2 | −9.425E−02 |
| | | | | | X4Y3 | 6.440E+00 | X3Y4 | −5.864E+01 | X2Y5 | −4.700E+01 |
| | | | | | XY6 | 9.158E+00 | Y7 | 5.834E+01 | X8 | −1.627E+01 |
| | | | | | X7Y | 7.570E−02 | X6Y2 | 5.417E+01 | X5Y3 | −5.144E−01 |
| | | | | | X4Y4 | −1.420E+03 | X3Y5 | −1.578E−02 | X2Y6 | 1.829E+02 |
| | | | | | XY7 | −3.707E−03 | Y8 | −1.290E+02 | X9 | −1.674E−01 |
| | | | | | X8Y | 2.947E+03 | X7Y2 | 1.318E−01 | X6Y3 | −1.942E+02 |
| | | | | | X5Y4 | 1.305E+00 | X4Y5 | 1.015E+02 | X3Y6 | 4.296E−01 |
| | | | | | X2Y7 | −5.387E+01 | XY8 | −1.140E−01 | Y9 | −9.956E+00 |
| | | | | | X10 | 1.333E+02 | X9Y | 4.981E+03 | X8Y2 | −1.931E+03 |
| | | | | | X7Y3 | −8.034E+03 | X6Y4 | −1.297E+04 | X5Y5 | 1.043E+04 |
| | | | | | X4Y6 | −1.596E+04 | X3Y7 | −8.474E+01 | X2Y8 | −1.625E+04 |
| | | | | | XY9 | −2.545E+02 | Y10 | −2.339E+03 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | 1.128E−01 | Y | −1.506E−01 | X2 | − [symbol] .492E−01 |
| | | | | | XY | −2.094E−01 | Y2 | −9.923E−01 | X3 | −1.284E+00 |
| | | | | | X2Y | −1.521E+00 | XY2 | −1.544E−01 | Y3 | −8.312E−01 |
| | | | | | X4 | −3.659E+00 | X3Y | −1.385E+00 | X2Y2 | −4.467E+00 |
| | | | | | XY3 | 8.212E−01 | Y4 | −2.971E+00 | X5 | 9.132E+00 |
| | | | | | X4Y | 1.496E+01 | X3Y2 | 3.218E+00 | X2Y3 | 9.137E+00 |
| | | | | | XY4 | 1.157E+00 | Y5 | 9.185E+00 | X6 | 3.992E+01 |
| | | | | | X5Y | 1.048E+02 | X4Y2 | 3.060E+01 | X3Y3 | 8.288E+01 |
| | | | | | X2Y4 | 2.501E+01 | XY5 | 2.117E+01 | Y6 | 2.019E+01 |
| | | | | | X7 | −5.089E−01 | X6Y | 3.821E+01 | X5Y2 | −1.358E+02 |
| | | | | | X4Y3 | 2.508E+02 | X3Y4 | 1.450E+02 | X2Y5 | −2.722E−01 |
| | | | | | XY6 | 4.652E+00 | Y7 | −1.007E+02 | X8 | −2.263E+02 |
| | | | | | X7Y | −7.552E+02 | X6Y2 | −1.107E−03 | X5Y3 | 3.540E−01 |
| | | | | | X4Y4 | 1.217E+02 | X3Y5 | 7.111E+02 | X2Y6 | 6.589E+02 |
| | | | | | XY7 | −1.645E+01 | Y8 | −1.159E+02 | X9 | −2.187E+02 |
| | | | | | X8Y | −2.438E+02 | X7Y2 | −5.118E−01 | X6Y3 | −8.200E+01 |
| | | | | | X5Y4 | −2.463E+03 | X4Y5 | −1.266E+02 | X3Y6 | −1.792E+03 |
| | | | | | X2Y7 | 2.949E+02 | XY8 | 1.971E−01 | Y9 | 3.611E+02 |
| | | | | | X10 | 2.638E+02 | X9Y | 2.932E+03 | X8Y2 | 5.195E+03 |
| | | | | | X7Y3 | 2.869E+03 | X6Y4 | −6.713E+03 | X5Y5 | −6.615E+03 |
| | | | | | X4Y6 | −1.380E+04 | X3Y7 | −9.750E+03 | X2Y8 | −1.040E+04 |
| | | | | | XY9 | 9.462E+02 | Y10 | 1.492E+02 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | −4.283E−04 | Y | −3.216E−02 | X2 | 2.003E+00 |
| | | | | | XY | −1.209E−04 | Y2 | 1.165E+00 | X3 | −2.680E−04 |
| | | | | | X2Y | −1.932E+00 | XY2 | −1.084E−03 | Y3 | −8.510E−01 |
| | | | | | X4 | −2.891E+00 | X3Y | 3.983E−03 | X2Y2 | 3.601E+00 |
| | | | | | XY3 | 1.714E−03 | Y4 | 2.321E+00 | X5 | 6.120E−03 |
| | | | | | X4Y | 2.694E+00 | X3Y2 | −1.465E−02 | X2Y3 | −2.248E+00 |
| | | | | | XY4 | 7.988E−03 | Y5 | 2.223E+00 | X6 | 4.380E+01 |
| | | | | | X5Y | 1.009E−02 | X4Y2 | 6.944E+01 | X3Y3 | 6.270E−02 |
| | | | | | X2Y4 | 9.703E+01 | XY5 | 6.229E−02 | Y6 | 2.004E+01 |
| | | | | | X7 | 8.757E−02 | X6Y | −1.995E+02 | X5Y2 | −2.734E−01 |
| | | | | | X4Y3 | −5.042E+01 | X3Y4 | 4.367E−01 | X2Y5 | 7.235E+01 |
| | | | | | XY6 | −1.257E−01 | Y7 | −1.632E+01 | X8 | −2.139E+02 |
| | | | | | X7Y | 1.709E+00 | X6Y2 | −3.154E+02 | X5Y3 | −5.113E−01 |
| | | | | | X4Y4 | −1.261E+03 | X3Y5 | 8.526E−01 | X2Y6 | −1.030E+03 |
| | | | | | XY7 | −1.094E+00 | Y8 | −2.169E+02 | X9 | 6.529E−01 |
| | | | | | X8Y | 1.718E+03 | X7Y2 | −5.369E+00 | X8Y3 | 1.64 [symbol] E+03 |
| | | | | | X5Y4 | 3.031E+00 | X4Y5 | −6.258E+02 | X3Y8 | −7.979E−01 |
| | | | | | X2Y7 | −2.917E+02 | XY8 | −5.399E−01 | Y9 | −4.715E+01 |
| | | | | | X10 | −1.270E+03 | X9Y | 4.151E+03 | X8Y2 | 3.113E+03 |
| | | | | | X7Y3 | −5.085E+02 | X6Y4 | 8.743E+03 | X5Y5 | 9. [symbol] 94E+03 |
| | | | | | X4Y6 | 9.156E+03 | X3Y7 | −2.486E+02 | X2Y8 | 9.480E−03 |
| | | | | | XY9 | 1.407E+03 | Y10 | 3.983E+02 | | |

[symbol]

indicates data missing or illegible when filed

TABLE 2G

| D2 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | −8.297405 | 0.182 | 0.000 | 0.000 | X | −3.705E−02 | Y | −2.230E−02 | X2 | 8.468E−01 |
| 2 | 1E+18 | 0.305 | 0.035 | 0.024 | XY | 1.313E−03 | Y2 | 8.562E−01 | X3 | −6.026E−02 |
| 3 | 1E+18 | 0.038 | 0.035 | 0.024 | X2Y | 6.192E−02 | XY2 | 1.655E−02 | Y3 | 1.246E−02 |
| 4 | 0.3495476 | 0.845 | 0.069 | 0.051 | X4 | 4.967E−01 | X3Y | −5.371E−02 | X2Y2 | 9.596E−01 |
| 5 | 0.4151953 | 0.067 | 0.408 | 0.267 | XY3 | −9.924E−02 | Y4 | 4.644E−01 | X5 | −1.725E−01 |
| 6 | 1E+18 | 0.300 | 0.408 | 0.267 | X4Y | 6.657E−03 | X3Y2 | −3.118E−01 | X2Y3 | −3.398E−02 |
| 7 | 1E+18 | 0.053 | 0.408 | 0.267 | XY4 | −2.565E−02 | Y5 | −5.548E−02 | X6 | 1.319E+00 |
| 8 | −0.397372 | 0.147 | 0.536 | 0.331 | X5Y | 1.860E+00 | X4Y2 | 9.578E−01 | X3Y3 | 3.518E+00 |
| 9 | 1E+18 | 0.500 | 0.698 | 0.416 | X2Y4 | 2.248E+00 | XY5 | 1.126E+00 | Y6 | 2.030E+00 |
| 10 | 1E+18 | 0.050 | 0.698 | 0.416 | X7 | 8.162E−01 | X6Y | 1.106E+00 | X5Y2 | 1.990E+00 |
| | | | | | X4Y3 | 5.285E+00 | X3Y4 | 1.707E+00 | X2Y5 | 4.253E+00 |
| | | | | | XY6 | 2.835E−01 | Y7 | 8.650E−01 | X8 | −4.123E+00 |
| | | | | | X7Y | −1.606E+01 | X6Y2 | 1.620E+01 | X5Y3 | −5.519E+01 |
| | | | | | X4Y4 | 1.871E+01 | X3Y5 | −5.022E+01 | X2Y6 | −5.401E+00 |
| | | | | | XY7 | −1.147E+01 | Y8 | −1.062E+01 | X9 | −5.037E+00 |
| | | | | | X8Y | −6.201E−01 | X7Y2 | −1.767E+01 | X6Y3 | −1.792E+01 |
| | | | | | X5Y4 | −2.223E+01 | X4Y5 | −2.988E+01 | X3Y6 | −9.723E+00 |
| | | | | | X2Y7 | −1.743E+01 | XY8 | −5.107E−01 | Y9 | −3.392E+00 |
| | | | | | X10 | 2.356E+01 | X9Y | 4.149E+01 | X8Y2 | −3.242E+00 |
| | | | | | X7Y3 | 2.141E+02 | X6Y4 | −1.984E+01 | X5Y5 | 3.147E+02 |
| | | | | | X4Y8 | 3.165E+01 | X3Y7 | 1.809E+02 | X2Y8 | 7.613E+01 |
| | | | | | XY9 | 2.763E+01 | Y10 | 4.031E+01 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | −2.312E−02 | Y | −2.524E−03 | X2 | −9.759E−01 |
| | | | | | XY | −9.726E−03 | Y2 | −9.510E−01 | X3 | 4.066E−02 |
| | | | | | X2Y | 4.731E−01 | XY2 | 2.684E−01 | Y3 | 3.058E−01 |
| | | | | | X4 | −1.619E+00 | X3Y | 1.789E−01 | X2Y2 | −3.149E+00 |
| | | | | | XY3 | 4.377E−02 | Y4 | −1.420E+00 | X5 | 7.148E−01 |
| | | | | | X4Y | 1.606E+00 | X3Y2 | 1.270E+00 | X2Y3 | 3.139E+00 |
| | | | | | XY4 | 1.070E+00 | Y5 | 1.706E+00 | X6 | −3.371E+01 |
| | | | | | X5Y | 6.648E+00 | X4Y2 | −1.015E+02 | X3Y3 | 1.202E+01 |
| | | | | | X2Y4 | −1.013E+02 | XY5 | 5.102E+00 | Y6 | −3.469E+01 |
| | | | | | X7 | −4.166E+00 | X6Y | −1.803E+00 | X5Y2 | −1.348E+01 |
| | | | | | X4Y3 | −4.976E−01 | X3Y4 | −7.592E+00 | X2Y5 | −1.606E+01 |
| | | | | | XY6 | −6.023E+00 | Y7 | −9.108E+00 | X8 | 3.892E+02 |
| | | | | | X7Y | −8.240E+01 | X6Y2 | 1.584E+03 | X5Y3 | −3.101E+02 |
| | | | | | X4Y4 | 2.284E+03 | X3Y5 | −2.765E+02 | X2Y6 | 1.615E+03 |
| | | | | | XY7 | −8.125E+01 | Y8 | 4.106E+02 | X9 | 4.300E+01 |
| | | | | | X8Y | 1.244E+02 | X7Y2 | 2.284E+02 | X6Y3 | 2.910E+02 |
| | | | | | X5Y4 | 2.784E+02 | X4Y5 | 5.322E+02 | X3Y6 | 2.158E+02 |
| | | | | | X2Y7 | 4.327E+02 | XY8 | 9.874E+01 | Y9 | 1.248E+02 |
| | | | | | X10 | −3.377E+03 | X9Y | 4.071E+02 | X8Y2 | −1.715E+04 |
| | | | | | X7Y3 | 2.457E+03 | X6Y4 | −3.267E+04 | X5Y5 | 3.885E+03 |
| | | | | | X4Y6 | −3.306E+04 | X3Y7 | 2.106E+03 | X2Y8 | −1.730E+04 |
| | | | | | XY9 | 4.902E+02 | Y10 | −3.382E+03 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | −2.625E−02 | Y | −1.103E−02 | X2 | −1.045E+00 |
| | | | | | XY | −2.755E−01 | Y2 | −1.073E+00 | X3 | −8.346E−01 |
| | | | | | X2Y | −4.149E−01 | XY2 | −8.959E−02 | Y3 | −6.702E−01 |
| | | | | | X4 | −3.235E+00 | X3Y | 1.775E+00 | X2Y2 | −4.568E+00 |
| | | | | | XY3 | 1.204E+00 | Y4 | −2.815E+00 | X5 | 1.776E+00 |
| | | | | | X4Y | −9.535E−01 | X3Y2 | 1.143E+00 | X2Y3 | 3.397E+00 |
| | | | | | XY4 | −2.761E+00 | Y5 | 3.168E+00 | X6 | 1.681E+01 |
| | | | | | X5Y | −1.384E+01 | X4Y2 | −2.920E+01 | X3Y3 | −4.807E+00 |
| | | | | | X2Y4 | −3.348E+01 | XY5 | −1.183E+01 | Y6 | 1.212E+01 |
| | | | | | X7 | −1.480E+01 | X6Y | 8.307E+01 | X5Y2 | 3.163E+00 |
| | | | | | X4Y3 | 2.588E+01 | X3Y4 | 5.494E+01 | X2Y5 | −9.252E−01 |
| | | | | | XY6 | 8.714E+01 | Y7 | −2.354E+01 | X3 | −3.066E+02 |
| | | | | | X7Y | 3.799E+02 | X6Y2 | 1.529E+02 | X5Y3 | 3.435E+02 |
| | | | | | X4Y4 | 7.142E+02 | X3Y5 | 2.025E+02 | X2Y6 | 4.508E+02 |
| | | | | | XY7 | 2.981E+02 | Y8 | −1.487E+02 | X9 | 1.275E+02 |
| | | | | | X8Y | −2.756E+02 | X7Y2 | 3.283E+02 | X6Y3 | −4.567E+02 |
| | | | | | X5Y4 | −3.808E+02 | X4Y5 | 2.103E+02 | X3Y6 | −3.901E+02 |
| | | | | | X2Y7 | 2.959E+01 | XY8 | −4.373E+02 | Y9 | 1.868E+02 |
| | | | | | X10 | 1.200E+03 | X9Y | −1.987E+03 | X8Y2 | −1.038E+03 |
| | | | | | X7Y3 | −2.909E+03 | X6Y4 | −7.146E+03 | X5Y5 | −2.367E+03 |
| | | | | | X4Y6 | −7.700E+03 | X3Y7 | −1.290E+03 | X2Y8 | −4.078E+03 |
| | | | | | XY9 | −1.739E+03 | Y10 | 4.979E+02 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | 4.876E−02 | Y | 7.061E−02 | X2 | 1.869E+00 |
| | | | | | XY | −5.646E−01 | Y2 | 1.671E+00 | X3 | −1.148E+00 |
| | | | | | X2Y | −9.191E−01 | XY2 | 2.195E−01 | Y3 | −1.196E+00 |
| | | | | | X4 | 1.410E+00 | X3Y | 3.976E+00 | X2Y2 | 2.318E−01 |
| | | | | | XY3 | 1.511E+00 | Y4 | 1.129E+00 | X5 | 1.794E+00 |
| | | | | | X4Y | −8.212E−01 | X3Y2 | 2.016E+00 | X2Y3 | 9.135E+00 |
| | | | | | XY4 | −5.633E+00 | Y5 | 4.897E+00 | X6 | −2.282E+01 |
| | | | | | X5Y | −4.261E+01 | X4Y2 | 1.345E+02 | X3Y3 | −1.974E+01 |
| | | | | | X2Y4 | 1.091E+06 | XY5 | −1.215E+01 | Y6 | 2.237E+01 |
| | | | | | X7 | −4.508E+01 | X6Y | −2.353E+01 | X5Y2 | −9.347E+01 |
| | | | | | X4Y3 | −6.228E+01 | X3Y4 | 2.737E+01 | X2Y5 | −1.395E+02 |
| | | | | | XY6 | 5.182E+01 | Y7 | −3.280E+01 | X8 | 1.360E+03 |
| | | | | | X7Y | 4.518E+02 | X6Y2 | −1.956E+03 | X5Y3 | 6.133E+02 |
| | | | | | X4Y4 | −1.977E+03 | X3Y5 | −3.783E+01 | X2Y6 | −1.164E+03 |
| | | | | | XY7 | 1.668E+02 | Y8 | − [symbol] .760E+01 | X9 | 7.687E+02 |
| | | | | | X8Y | 7.172E+02 | X7Y2 | 1.216E+03 | X6Y3 | 3.627E+02 |
| | | | | | X5Y4 | −4.235E+01 | X4Y5 | 5.632E+02 | X3Y6 | −2.750E+02 |
| | | | | | X2Y7 | 8.056E+02 | XY8 | 5.482E+01 | Y9 | 1.458E+02 |
| | | | | | X10 | −1.389E+04 | X9Y | −8.244E+02 | X8Y2 | 1.277E+04 |
| | | | | | X7Y3 | −5.559E+03 | X6Y4 | 1.833E+04 | X5Y5 | −6.148E+02 |
| | | | | | X4Y6 | 1.801E+04 | X3Y7 | 1.062E+03 | X2Y8 | 7.421E+03 |
| | | | | | XY9 | −5.544E+02 | Y10 | 9.101E+02 | | |

[symbol]

indicates data missing or illegible when filed

### Comparative Example

The followings are the construction data of comparative examples. In the comparative examples, the respective photographing ranges of the ommatidium lenses are equal to each other. Except it, the constitutions are the same as the constitutions of Examples.

TABLE 3A
C

| FACE | RADIUS OF | | INDEX OF | ABBE'S |
|---|---|---|---|---|
| NUMBER | CURVATURE | DISTANCE | REFRACTION | NUMBER |
| 1 | 0.6460034 | 0.215 | 1.518 | 56.1 |
| 2 | inf | 0.305 | 1.510 | 62.4 |
| 3 | inf | 0.104 | 1.602 | 28.6 |
| 4 | 1.2964102 | 0.670 | | |
| 5 | −3.005563 | 0.177 | 1.602 | 28.6 |
| 6 | inf | 0.300 | 1.510 | 62.4 |
| 7 | inf | 0.050 | 1.518 | 56.1 |
| 8 | 1.9927242 | 0.150 | | |
| 9 | inf | 0.500 | 1.471 | 66.02 |
| 10 | inf | 0.050 | | |

| ASPHERICAL | | | | | | | | |
|---|---|---|---|---|---|---|---|---|
| SURFACE | | | | | | | | |
| COEFFICIENT | | | | | | | | |
| FIRST FACE | 4th | −7.010E−03 | 6th | 2.148E+00 | 8th | −1.585E+01 | 10th | 4.716E+01 |
| | 12th | 1.175E+01 | 14th | 2.749E+02 | 18th | −1.818E+03 | k | −1.746E−01 |
| FOURTH FACE | 4th | 1.183E−01 | 6th | −1.815E+00 | 8th | 2.521E+01 | 10th | −9.758E+00 |
| | 12th | −1.788E+03 | 14th | −9.950E+02 | 16th | 4.494E+04 | k | 1.055E+01 |
| FIFTH FACE | 4th | −1.136E+00 | 6th | 9.251E+00 | 8th | −1.429E+02 | 10th | 7.141E+02 |
| | 12th | 5.089E+03 | 14th | −7.277E+04 | 16th | 2.465E+05 | k | 9.028E+00 |
| EIGHTH FACE | 4th | −1.865E+00 | 6th | 3.098E+01 | 8th | −4.474E+02 | 10th | 3.612E+03 |
| | 12th | −1.537E+04 | 14th | 2.919E+04 | 16th | −1.234E+04 | k | 2.393E+00 |

| V1 180 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 1.053475 | 0.199 | 0.000 | Y | −4.325E−02 | X2 | 3.018E−01 | Y2 | 3.054E−01 |
| 2 | inf | 0.305 | 0.045 | X2Y | −2.536E−02 | Y3 | −5.629E−03 | X4 | 3.347E−01 |
| 3 | inf | 0.050 | 0.045 | X2Y2 | 7.308E−01 | Y4 | 2.903E−01 | X4Y | −1.960E−02 |
| 4 | 0.7692705 | 0.823 | 0.079 | X2Y3 | −1.532E−01 | Y5 | −3.175E−02 | X8 | 5.090E−01 |
| 5 | 0.6896509 | 0.077 | 0.504 | X4Y2 | 1.094E+00 | X2Y4 | 1.078E+00 | Y6 | 3.011E−01 |
| 6 | inf | 0.300 | 0.504 | X6Y | −2.783E−01 | X4Y3 | −1.706E+00 | X2Y5 | −4.163E−01 |
| 7 | inf | 0.055 | 0.504 | Y7 | 3.387E−01 | X8 | 6.822E−11 | X6Y2 | 8.874E+00 |
| 8 | −0.415047 | 0.145 | 0.735 | X4Y4 | 1.759E+01 | X2Y6 | 7.877E+00 | Y8 | 8.002E−01 |
| 9 | inf | 0.500 | 0.948 | X8Y | 1.072E+00 | X6Y3 | 1.127E+01 | X4Y5 | 9.707E+00 |
| 10 | inf | 0.050 | 0.948 | X2Y7 | −2.971E−01 | Y9 | −7.859E−01 | X10 | 3.088E+00 |
| | | | | X8Y2 | −1.062E+01 | X6Y4 | −6.735E+01 | X4Y6 | −5.887E+01 |
| | | | | X2Y8 | −1.573E+01 | | | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −1.689E−02 | X2 | −1.432E−01 | Y2 | −1.780E−01 |
| | | | | X2Y | 2.679E−01 | Y3 | 3.970E−01 | X4 | 3.168E−01 |
| | | | | X2Y2 | 1.080E+00 | Y4 | 3.399E−01 | X4Y | 7.221E−01 |
| | | | | X2Y3 | 1.486E+00 | Y5 | 8.810E−01 | X8 | 3.416E+00 |
| | | | | X4Y2 | 9.748E+00 | X2Y4 | 1.002E+01 | Y6 | 3.700E+00 |
| | | | | X6Y | 6.573E+00 | X4Y3 | 8.323E+00 | X2Y5 | 6.856E+00 |
| | | | | Y7 | 1.417E+00 | X8 | −2.826E+01 | X6Y2 | −8.897E+01 |
| | | | | X4Y4 | −1.787E+02 | X2Y6 | −1.174E+02 | Y8 | −3.869E+01 |
| | | | | X8Y | 2.017E+01 | X6Y3 | 1.241E+02 | X4Y5 | 2.553E+02 |
| | | | | X2Y7 | 1.538E+02 | Y9 | 3.680E+01 | X10 | 2.098E+02 |
| | | | | X8Y2 | 8.087E+02 | X6Y4 | 2.270E+03 | X4Y6 | 2.311E+03 |
| | | | | X2Y8 | 1.038E+03 | Y10 | 2.675E+02 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | −2.024E−03 | X2 | −2.600E−01 | Y2 | −5.5 [symbol] 7E−01 |
| | | | | X2Y | −7.400E−01 | Y3 | −1.671E−01 | X4 | −1.696E+00 |
| | | | | X2Y2 | −1.359E+00 | Y4 | −1.146E+00 | X4Y | 5.334E−01 |
| | | | | X2Y3 | 3.010E+00 | Y5 | 6.455E−01 | X6 | 4.308E+00 |
| | | | | X4Y2 | 2.307E−01 | X2Y4 | 6.352E+00 | Y6 | 9.207E+00 |
| | | | | X6Y | −1.757E−01 | X4Y3 | 2.174E+00 | X2Y5 | −2.390E+00 |
| | | | | Y7 | 2.246E+01 | X8 | −4.428E+01 | X6Y2 | −2.146E+01 |
| | | | | X4Y4 | 5.247E+01 | X2Y6 | −1.306E+02 | Y8 | −8.736E+01 |
| | | | | X8Y | 5.792E+01 | X6Y3 | 8.868E+01 | X4Y5 | 8.460E+01 |
| | | | | X2Y7 | 1.633E+02 | Y9 | −6.177E+01 | X10 | 1.272E+02 |
| | | | | X8Y2 | 8.398E+01 | X6Y4 | −5.675E+02 | X4Y6 | −2.666E+01 |
| | | | | X2Y8 | 1.417E+02 | Y10 | 9.684E+01 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 1.022E−01 | X2 | 2.100E+00 | Y2 | 1.395E+00 |
| | | | | X2Y | −1.599E+00 | Y3 | −6.396E−01 | X4 | −9.601E−01 |
| | | | | X2Y2 | 4.492E+00 | Y4 | 2.603E+00 | X4Y | 1.755E+00 |
| | | | | X2Y3 | 2.784E+00 | Y5 | 6.659E+00 | X6 | 3.189E+01 |
| | | | | X4Y2 | 7.365E+01 | X2Y4 | 1.13 [symbol] E+01 | Y6 | 2.065E+01 |
| | | | | X6Y | −2.991E+01 | X4Y3 | 1.816E+01 | X2Y5 | −6.354E+01 |
| | | | | Y7 | 3.058E+01 | X8 | −2.340E+02 | X6Y2 | −7.899E+02 |
| | | | | X4Y4 | −5.394E+02 | X2Y6 | 2.080E+01 | Y8 | −2.308E+02 |
| | | | | X8Y | 1.404E+02 | X6Y3 | 2.005E+02 | X4Y5 | 7.867E+01 |
| | | | | X2Y7 | 1.035E+03 | Y9 | −1.681E+03 | X10 | 1.180E+03 |
| | | | | X8Y2 | 4.645E+03 | X6Y4 | 7.717E+03 | X4Y6 | 5.714E+03 |
| | | | | X2Y8 | 2.336E+03 | Y10 | −2.524E+03 | | |

[symbol]

indicates data missing or illegible when filed

TABLE 3B

| V2 180 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 0.9306043 | 0.270 | 0.000 | Y | −6.513E−02 | X2 | 2.353E−01 | Y2 | 2.457E−01 |
| 2 | inf | 0.305 | 0.012 | X2Y | −6.131E−02 | Y3 | −4.256E−02 | X4 | 2.702E−01 |
| 3 | inf | 0.050 | 0.012 | X2Y2 | 6.442E−01 | Y4 | 2.822E−01 | X4Y | −9.807E−02 |
| 4 | 0.7439655 | 0.809 | 0.025 | X2Y3 | −3.082E−01 | Y5 | −1.097E−01 | X8 | 1.938E−01 |
| 5 | 1.2197608 | 0.091 | 0.244 | X4Y2 | 6.440E−01 | X2Y4 | 9.807E−01 | Y6 | 4.391E−01 |
| 6 | inf | 0.300 | 0.244 | X6Y | 5.312E−02 | X4Y3 | 7.721E−01 | X2Y5 | 1.516E+00 |
| 7 | inf | 0.053 | 0.244 | Y7 | 3.984E−01 | X8 | 1.882E+00 | X6Y2 | 8.377E+00 |
| 8 | −0.425158 | 0.147 | 0.377 | X4Y4 | 1.345E+01 | X2Y6 | 5.701E+00 | Y8 | 8.778E−01 |
| 9 | inf | 0.500 | 0.492 | X8Y | −1.082E+00 | X6Y3 | −6.238E+00 | X4Y5 | −1.338E+01 |
| 10 | inf | 0.050 | 0.492 | X2Y7 | −1.047E+01 | Y9 | −1.607E+00 | X10 | −3.004E−01 |
| | | | | X6Y2 | −1.017E+00 | X6Y4 | −9.320E+00 | X4Y6 | −1.584E+00 |
| | | | | X2Y8 | 6.307E+00 | Y10 | 1.112E+00 | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −9.677E−02 | X2 | −1.413E−01 | Y2 | −1.989E−01 |
| | | | | X2Y | −6.027E−02 | Y3 | 8.079E−02 | X4 | 4.015E−01 |
| | | | | X2Y2 | 1.300E+00 | Y4 | 4.937E−01 | X4Y | 5.813E−01 |
| | | | | X2Y3 | 1.019E+00 | Y5 | 5.420E−01 | X8 | 8.224E−01 |
| | | | | X4Y2 | 2.882E+00 | X2Y4 | −5.374E−02 | Y6 | −1.597E+00 |
| | | | | X6Y | −7.342E+00 | X4Y3 | −2.169E+01 | X2Y5 | −1.156E+01 |
| | | | | Y7 | −2.274E−01 | X8 | 1.058E+01 | X6Y2 | 3.531E+01 |
| | | | | X4Y4 | 8.026E+01 | X2Y6 | 7.830E+01 | Y8 | 2.233E+01 |
| | | | | X8Y | 2.145E+01 | X6Y3 | 6.858E+01 | X4Y5 | 5.850E+01 |
| | | | | X2Y7 | 4.444E+00 | Y9 | −2.743E+00 | X10 | 3.527E+01 |
| | | | | X6Y2 | 3.248E+02 | X6Y4 | 8.342E+02 | X4Y6 | 6.604E+02 |
| | | | | X2Y8 | 2.246E+02 | Y10 | 3.489E+01 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | −4.940E−02 | X2 | 7.005E−02 | Y2 | −3.078E−01 |
| | | | | X2Y | −5.021E−01 | Y3 | −7.736E−02 | X4 | −1.408E+00 |
| | | | | X2Y2 | −1.186E+00 | Y4 | −1.564E+00 | X4Y | 7.462E−01 |
| | | | | X2Y3 | 3.533E+00 | Y5 | 1.187E−01 | X6 | 3.447E+00 |
| | | | | X4Y2 | 1.197E+00 | X2Y4 | 1.022E+00 | Y6 | 1.188E+01 |
| | | | | X6Y | −2.545E+00 | X4Y3 | −1.983E+01 | X2Y5 | −3.557E+01 |
| | | | | Y7 | 3.210E+01 | X8 | −3.396E+01 | X6Y2 | −2.900E+01 |
| | | | | X4Y4 | 1.546E+02 | X2Y6 | −4.924E+01 | Y8 | −1.812E+02 |
| | | | | X8Y | 5.290E+01 | X6Y3 | 1.691E+02 | X4Y5 | 3.547E+02 |
| | | | | X2Y7 | 3.777E+02 | Y9 | −1.893E+02 | X10 | 6.110E+01 |
| | | | | X8Y2 | 7.882E−01 | X6Y4 | −7.682E+02 | X4Y6 | −9.488E+02 |
| | | | | X2Y8 | −5.715E−01 | Y10 | 8.378E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 9.465E−02 | X2 | 2.181E+00 | Y2 | 1.497E+00 |
| | | | | X2Y | −1.186E+00 | Y3 | −6.775E−01 | X4 | −1.318E+00 |
| | | | | X2Y2 | 1.868E+00 | Y4 | 2.186E−01 | X4Y | 1.736E+00 |
| | | | | X2Y3 | 5.615E+00 | Y5 | 4.605E+00 | X6 | 2.635E+01 |
| | | | | X4Y2 | 8.486E+01 | X2Y4 | 3.888E+01 | Y6 | 1.825E+01 |
| | | | | X6Y | −1.007E+01 | X4Y3 | −4.099E+00 | X2Y5 | −7.264E+01 |
| | | | | Y7 | −7.486E+00 | X8 | −1.693E+02 | X6Y2 | −8.726E+02 |
| | | | | X4Y4 | −9.110E+02 | X2Y6 | −3.088E+02 | Y8 | −1.318E+02 |
| | | | | X8Y | 6.889E+01 | X6Y3 | 1.532E+02 | X4Y5 | 1.979E+02 |
| | | | | X2Y7 | 5.924E+02 | Y9 | −2.859E+02 | X10 | 6.747E+02 |
| | | | | X8Y2 | 4.240E+03 | X6Y4 | [symbol] .923E+03 | X4Y6 | 6.639E+03 |
| | | | | X2Y8 | 2.673E+03 | Y10 | −1.169E+02 | | |
| H1 90 DEGREE ROTATION | | | | FREE | | | | | |
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 0.9913045 | 0.130 | 0.000 | X2 | 1.936E−01 | Y2 | 2.563E−01 | X2Y | 9.616E−02 |
| 2 | inf | 0.305 | 0.034 | Y3 | 2.222E−02 | X4 | 1.880E−01 | X2Y2 | 5.244E−01 |
| 3 | inf | 0.050 | 0.034 | Y4 | 2.714E−01 | X4Y | 1.516E−01 | X2Y3 | −1.306E−01 |
| 4 | 0.6907213 | 0.841 | 0.057 | Y5 | −6.855E−02 | X6 | 4.912E−01 | X4Y2 | 2.535E+00 |
| 5 | 0.805473 | 0.059 | 0.674 | X2Y4 | 2.083E+00 | Y6 | 4.973E−01 | X6Y | 1.264E+00 |
| 6 | inf | 0.300 | 0.674 | X4Y3 | 3.807E+00 | X2Y5 | 2.047E+00 | Y7 | 2.012E−01 |
| 7 | inf | 0.056 | 0.674 | X8 | −9.885E−01 | X6Y2 | −1.309E+01 | X4Y4 | −7.424E+00 |
| 8 | −0.412981 | 0.143 | 0.920 | X2Y6 | 3.240E+00 | Y8 | 1.691E+00 | X8Y | 4.976E−01 |
| 9 | inf | 0.500 | 1.175 | X6Y3 | −1.469E+01 | X4Y5 | −1.582E+01 | X2Y7 | −1.148E+01 |
| 10 | inf | 0.051 | 1.175 | Y9 | −1.394E+00 | X10 | 4.280E+00 | X8Y2 | 6.644E+01 |
| | | | | X6Y4 | 1.301E+02 | X4Y6 | 1.755E+00 | X2Y8 | −5.621E+00 |
| | | | | Y10 | 3.939E−01 | | | | |
| | | | | FREE | | | | | |
| | | | | SPHERICAL | | | | | |
| | | | | SURFACE | FOURTH | | | | |
| | | | | COEFFICIENT | FACE | | | | |
| | | | | Y | −1.818E−02 | X2 | −2.299E−01 | Y2 | −1.051E−01 |
| | | | | X2Y | 3.316E−01 | Y3 | 2.921E−01 | X4 | 1.141E−01 |
| | | | | X2Y2 | 1.101E+00 | Y4 | 5.427E−01 | X4Y | 8.485E−01 |
| | | | | X2Y3 | 1.279E+00 | Y5 | 8.820E−01 | X6 | 8.949E−01 |
| | | | | X4Y2 | 1.829E+00 | X2Y4 | 4.067E+00 | Y6 | 1.923E+00 |
| | | | | X6Y | 1.425E+01 | X4Y3 | 2.173E+01 | X2Y5 | −2.211E+01 |
| | | | | Y7 | −1.478E+01 | X8 | −1.085E+01 | X6Y2 | 3.493E+01 |
| | | | | X4Y4 | −6.933E+01 | X2Y6 | 7.950E+01 | Y8 | 2.968E+01 |
| | | | | X8Y | 6.963E+01 | X6Y3 | −2.110E+02 | X4Y5 | 3.388E+02 |
| | | | | X2Y7 | 1.914E+02 | Y9 | 3.650E+01 | X10 | 5.160E+01 |
| | | | | X8Y2 | −4.839E+01 | X6Y4 | 1.255E+03 | X4Y6 | 2.735E+02 |
| | | | | X2YB | −2.315E+02 | Y10 | 1.253E+01 | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | 1.047E−02 | X3 | −3.352E−01 | Y2 | −4.840E−01 |
| | | | | X2Y | −1.163E+00 | Y3 | −6.936E−01 | X4 | −1.974E+00 |
| | | | | X2Y2 | −1.348E+00 | Y4 | −6.347E−01 | X4Y | −3.129E−01 |
| | | | | X2Y3 | 3.620E−01 | Y5 | 3.092E+00 | X6 | 9.391E+00 |
| | | | | X4Y2 | 8.034E+00 | X2Y4 | 1.626E+01 | Y6 | 1.310E+01 |
| | | | | X6Y | −8.923E−01 | X4Y3 | 3.241E+01 | X2Y5 | 4.163E+01 |
| | | | | Y7 | −3.489E+00 | X8 | −1.381E+02 | X6Y2 | −1.943E+02 |
| | | | | X4Y4 | −6.514E+01 | X2Y6 | −1.542E+02 | Y8 | −1.114E+02 |
| | | | | X8Y | 5.966E+01 | X6Y3 | 8.300E+01 | X4Y5 | −1.790E+02 |
| | | | | X2Y7 | −1.620E+02 | Y9 | −2.936E+01 | X10 | 2.329E+02 |
| | | | | X8Y2 | 3.833E+02 | X6Y4 | 1.797E+03 | X4Y6 | 5.972E+02 |
| | | | | X2Y8 | 4.953E+02 | Y10 | 3.739E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y | 6.299E−02 | X2 | 1.927E+00 | Y2 | 1.225E+00 |
| | | | | X2Y | −2.265E+00 | Y3 | −9.192E−01 | X4 | −1.217E+00 |
| | | | | X2Y2 | 3.934E+00 | Y4 | 3.165E+00 | X4Y | 9.604E−00 |
| | | | | X2Y3 | −1.358E+00 | Y5 | 3.762E+00 | X6 | 4.942E+01 |
| | | | | X4Y2 | 7.521E+01 | X2Y4 | 8.544E+01 | Y6 | 2.110E+01 |
| | | | | X6Y | −2.514E+02 | X4Y3 | −1.118E+02 | X2Y5 | 3.797E+01 |
| | | | | Y7 | −7.799E+00 | X8 | −3.397E+02 | X6Y2 | −3.887E+02 |
| | | | | X4Y4 | −1.322E+03 | X2Y6 | −7.007E+02 | Y8 | −2.160E+02 |
| | | | | X8Y | 1.997E+03 | X6Y3 | 2.217E+03 | X4Y5 | 1.674E+02 |
| | | | | X2Y7 | −2.335E+02 | Y9 | −1.728E+02 | X10 | −8.931E+02 |
| | | | | X8Y2 | −1.321E+03 | X6Y4 | 1.029E+04 | X4Y6 | 1.208E+04 |
| | | | | X2Y8 | 4.056E+03 | Y10 | 7.444E+02 | | |

[symbol]

indicates data missing or illegible when filed

TABLE 3C

| H2 90 DEGREE ROTATION | | | | FREE | | | | | |
|---|---|---|---|---|---|---|---|---|---|
| | | | Y | SPHERICAL | | | | | |
| FACE | RADIUS OF | DIS- | ECCEN- | SURFACE | FIRST | | | | |
| NUMBER | CURVATURE | TANCE | TRICITY | COEFFICIENT | FACE | | | | |
| 1 | 1.1172005 | 0.245 | 0.000 | Y | −4.954E−02 | X2 | 3.243E−01 | Y2 | 3.151E−01 |
| 2 | inf | 0.305 | 0.018 | X2Y | −5.172E−02 | Y3 | −2.580E−02 | X4 | 3.508E−01 |
| 3 | inf | 0.050 | 0.018 | X2Y2 | 7.229E−01 | Y4 | 2.829E−01 | X4Y | −1.450E−01 |
| 4 | 0.7821352 | 0.788 | 0.034 | X2Y3 | −4.168E−01 | Y5 | −9.141E−02 | X6 | 2.335E−01 |
| 5 | 0.8259363 | 0.111 | 0.379 | X4Y2 | 8.232E−01 | X2Y4 | 1.067E+00 | Y6 | 3.770E−01 |
| 6 | inf | 0.300 | 0.379 | X6Y | 2.508E−01 | X4Y3 | 1.477E+00 | X2Y5 | 2.311E+00 |
| 7 | inf | 0.055 | 0.379 | Y7 | 4.355E−01 | X8 | 2.314E+00 | X6Y2 | 8.888E+00 |
| 8 | −0.437289 | 0.145 | 0.531 | X4Y4 | 1.056E+01 | X2Y6 | 3.781E+00 | Y8 | 3.948E−01 |
| 9 | inf | 0.500 | 0.650 | X8Y | −1.407E+00 | X6Y3 | −5.932E+00 | X4Y5 | −1.343E+01 |
| 10 | inf | 0.050 | 0.650 | X2Y7 | −9.848E+00 | Y9 | −9.994E−02 | X10 | −3.997E−01 |
| | | | | X8Y2 | −2.328E+00 | X6Y4 | −6.662E+00 | X4Y6 | 4.381E+00 |
| | | | | X2Y8 | 7.440E−02 | Y10 | −8.466E−01 | | |
| | | | | FREE | | | | | |
| | | | | SPHERICAL | | | | | |
| | | | | SURFACE | FOURTH | | | | |
| | | | | COEFFICIENT | FACE | | | | |
| | | | | X2 | −1.387E−01 | Y2 | −2.148E−01 | X2Y | 6.704E−02 |
| | | | | Y3 | 2.118E−01 | X4 | 3.951E−01 | X2Y2 | 1.005E+00 |
| | | | | Y4 | 2.830E−01 | X4Y | 7.857E−01 | X2Y3 | 1.758E+00 |
| | | | | Y5 | 1.119E+00 | X6 | 1.580E+00 | X4Y2 | 4.095E+00 |
| | | | | X2Y4 | 5.426E−02 | Y6 | −2.156E+00 | X6Y | −6.054E+00 |
| | | | | X4Y3 | −8.901E+00 | X2Y5 | −9.472E+00 | Y7 | −5.714E−01 |
| | | | | X8 | 2.038E+00 | X6Y2 | −5.710E+00 | X4Y4 | −2.034E+01 |
| | | | | X2Y6 | 2.918E+01 | Y8 | 1.463E+01 | X8Y | 4.878E+01 |
| | | | | X6Y3 | 1.017E+02 | X4Y5 | 5.807E+01 | X2Y7 | 9.954E+01 |
| | | | | Y [symbol] | 5.145E+00 | X10 | 6.403E+01 | X [symbol] Y2 | 3.677E+02 |
| | | | | X6Y4 | 1.007E+03 | X4Y6 | 9.537E+02 | X2Y8 | 6.433E+01 |
| | | | | Y10 | 2.011E+01 | | | | |
| | | | | FREE | | | | | |
| | | | | SPHERICAL | | | | | |
| | | | | SURFACE | FIFTH | | | | |
| | | | | COEFFICIENT | FACE | | | | |
| | | | | Y | 1.007E−01 | X2 | −1.844E−01 | Y2 | −3.335E−01 |
| | | | | X2Y | −3.859E−01 | Y3 | −3.563E−02 | X4 | −1.458E+00 |
| | | | | X2Y2 | −1.510E+00 | Y4 | −1.501E+00 | X4Y | 8.549E−01 |
| | | | | X2Y3 | 3.322E+00 | Y5 | −3.589E−01 | X6 | 2.701E+00 |
| | | | | X4Y2 | 2.733E+00 | X2Y4 | 2.043E+00 | Y6 | 1.214E+01 |
| | | | | X6Y | −5.574E+00 | X4Y3 | −1.790E+01 | X2Y5 | −2.999E+01 |
| | | | | Y7 | 2.848E+01 | X8 | −1.717E+01 | X6Y2 | −3.452E+01 |
| | | | | X4Y4 | 1.104E+02 | X2Y6 | −4.503E+01 | Y8 | −1.384E+02 |
| | | | | X8Y | 5.864E+01 | X6Y3 | 1.562E+02 | X4Y5 | 2.455E+02 |
| | | | | X2Y7 | 2.038E+02 | Y9 | −1.519E+02 | X10 | 2.548E+01 |
| | | | | X8Y2 | 1.205E+02 | X6Y4 | −7.626E+02 | X4Y6 | −3.345E+02 |
| | | | | X2Y8 | −2.978E+01 | Y10 | 4.825E+02 | | |
| | | | | FREE | | | | | |
| | | | | SPHERICAL | | | | | |
| | | | | SURFACE | EIGHTH | | | | |
| | | | | COEFFICIENT | FACE | | | | |
| | | | | Y: | 1.325E−01 | X2: | 2.107E+00 | Y2: | 1.678E+00 |
| | | | | X2Y: | −1.273E+00 | Y3: | −9.793E−01 | X4: | −1.681E+00 |
| | | | | X2Y2: | 1.314E+00 | Y4: | 5.314E−02 | X4Y: | 1.776E+00 |
| | | | | X2Y3: | 6.403E+00 | Y5: | 8.766E+00 | X6: | 3.116E+01 |
| | | | | X4Y2: | 9.580E+01 | X2Y4: | 3.465E+01 | Y6: | 2.793E+01 |
| | | | | X6Y: | −1.841E+01 | X4Y3: | −1.457E+01 | X2Y5: | −7.066E+01 |
| | | | | Y7: | −5.802E+01 | X8: | −2.288E+02 | X6Y2: | −9.338E+02 |
| | | | | X4Y4: | −8.646E+02 | X2Y6: | −2.668E+02 | Y8: | −2.904E+02 |
| | | | | X8Y: | 4.656E+00 | X6Y3: | 3.206E+02 | X4Y5: | 4.189E+02 |
| | | | | X2Y7: | 4.302E+02 | Y9: | −1.286E+02 | X10: | 1.134E+03 |
| | | | | X8Y2: | 3.859E+03 | X6Y4: | 7.595E+03 | X4Y6: | 6.581E+03 |
| | | | | X2Y8: | 1.996E+03 | XY9: | −2.026E−02 | Y10: | 3.982E+02 |

[symbol]

indicates data missing or illegible when filed

TABLE 3D

| VD 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | −4.007562 | 0.255 | 0.000 | 0.000 | X | 1.048E−02 | Y | −5.920E−02 | X2 | 7.153E−01 |
| 2 | inf | 0.305 | 0.046 | 0.060 | XY | 1.199E−02 | Y2 | 7.251E−01 | X3 | 4.728E−02 |
| 3 | inf | 0.050 | 0.046 | 0.060 | X2Y | 1.331E−01 | XY2 | 5.140E−02 | Y3 | 2.544E−02 |
| 4 | 0.39908 | 0.831 | 0.091 | 0.123 | X4 | 2.034E−01 | X3Y | −1.067E−01 | X2Y2 | 2.850E−01 |
| 5 | 0.3737848 | 0.069 | 0.369 | 0.458 | XY3 | 2.055E−02 | Y4 | 1.625E−01 | X5 | 8.613E−02 |
| 6 | inf | 0.300 | 0.369 | 0.458 | X4Y | 2.107E−01 | X3Y2 | 8.930E−02 | X2Y3 | 2.773E−01 |
| 7 | inf | 0.051 | 0.369 | 0.458 | XY4 | −1.434E−02 | Y5 | 8.685E−02 | X6 | 3.060E−01 |
| 8 | −0.403499 | 0.148 | 0.472 | 0.678 | X5Y | 1.279E−02 | X4Y2 | 4.718E−01 | X3Y3 | −1.309E−02 |
| 9 | inf | 0.500 | 0.612 | 0.871 | X2Y4 | 4.529E−02 | XY5 | 1.430E−01 | Y6 | −1.545E−01 |
| 10 | inf | 0.050 | 0.612 | 0.871 | X7 | 1.328E−01 | X6Y | 3.938E−01 | X5Y2 | 9.140E−01 |
| | | | | | X4Y3 | 7.152E−01 | X3Y4 | 9.272E−01 | X2Y5 | 8.218E−01 |
| | | | | | XY6 | 4.009E−01 | Y7 | 3.219E−01 | X8 | 3.107E−02 |
| | | | | | X7Y | −1.137E+00 | X6Y2 | −5.276E−01 | X5Y3 | −1.221E+00 |
| | | | | | X4Y4 | 7.040E−01 | X3Y5 | −1.521E+00 | X2Y6 | 1.085E+00 |
| | | | | | XY7 | −3.583E−01 | Y8 | 6.159E−01 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | −6.333E−03 | Y | −2.085E−02 | X2 | −1.003E+00 |
| | | | | | XY | 4.218E−02 | Y2 | −9.879E−01 | X3 | 2.678E−01 |
| | | | | | X2Y | 5.898E−01 | XY2 | 2.720E−01 | Y3 | 2.542E−01 |
| | | | | | X4 | −1.499E+00 | X3Y | 3.335E−01 | X2Y2 | −3.314E+00 |
| | | | | | XY3 | 5.822E−01 | Y4 | −1.876E+00 | X5 | 4.665E−01 |
| | | | | | X4Y | 5.315E−01 | X3Y2 | 6.277E−01 | X2Y3 | 9.438E−01 |
| | | | | | XY4 | 3.736E−01 | Y5 | 3.465E−01 | X6 | −2.083E+00 |
| | | | | | X5Y | 3.963E−02 | X4Y2 | −8.798E+00 | X3Y3 | −1.129E+00 |
| | | | | | X2Y4 | −9.068E+00 | XY5 | −7.875E−02 | Y6 | −2.454E+00 |
| | | | | | X7 | 5.825E+00 | X6Y | 1.232E+01 | X5Y2 | 1.584E+01 |
| | | | | | X4Y3 | 1.792E+01 | X3Y4 | 1.393E+01 | X2Y5 | 1.341E+01 |
| | | | | | XY6 | 4.576E+00 | Y7 | 2.413E+00 | X8 | −5.091E+01 |
| | | | | | X7Y | 1.838E+01 | X6Y2 | −2.097E+02 | X5Y3 | 6.802E+01 |
| | | | | | X4Y4 | −3.220E+02 | X3Y5 | 4.683E+01 | X2Y6 | −2.367E+02 |
| | | | | | XY7 | 1.224E+01 | Y8 | −6.568E+01 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | −1.0 [symbol] 8E−01 | Y | −3.856E−02 | X2 | −1.600E+00 |
| | | | | | XY | −3.156E−01 | Y2 | −1.075E+00 | X3 | −1.359E+00 |
| | | | | | X2Y | 3.814E−01 | XY2 | −1.029E+00 | Y3 | −4.265E−01 |
| | | | | | X4 | −2.617E+00 | X3Y | 1.667E+00 | X2Y2 | −4.696E+00 |
| | | | | | XY3 | 1.605E+00 | Y4 | −3.391E+00 | X5 | −5.712E+00 |
| | | | | | X4Y | 1.786E+00 | X3Y2 | 3.536E+00 | X2Y3 | 7.114E+00 |
| | | | | | XY4 | −7.329E−01 | Y5 | 2.370E−01 | X6 | −3.350E+01 |
| | | | | | X5Y | −3.073E−01 | X4Y2 | −1.035E+02 | X3Y3 | 4.341E−01 |
| | | | | | X2Y4 | −1.099E+02 | XY5 | 1.275E+01 | Y6 | −1.352E+01 |
| | | | | | X7 | 8.754E+01 | X6Y | 6.640E+01 | X5Y2 | −1.381E+02 |
| | | | | | X4Y3 | 1.428E+00 | X3Y4 | −1.007E+02 | X2Y5 | −4.283E+01 |
| | | | | | XY6 | 5.790E−01 | Y7 | 1.101E+01 | X8 | 3.935E+02 |
| | | | | | X7Y | 7.622E+02 | X6Y2 | 1.428E+03 | X5Y3 | 7.019E+02 |
| | | | | | X4Y4 | 2.040E+03 | X3Y5 | −1.12 [symbol] E+02 | X2Y6 | 1.368E+03 |
| | | | | | XY7 | −2.036E+02 | Y8 | 4.797E+01 | X9 | 3.167E+00 |
| | | | | | X8Y | 2.574E+02 | X7Y2 | 1.823E+03 | X6Y3 | −1.895E+02 |
| | | | | | X5Y4 | 1.911E+03 | X4Y5 | 5.019E+02 | X3Y6 | 5.259E+02 |
| | | | | | X2Y7 | 4.153E+02 | XY8 | 5.020E+01 | Y9 | −1.318E+02 |
| | | | | | X10 | −5.887E+02 | X9Y | −7.696E+03 | X8Y2 | −1.232E+04 |
| | | | | | X7Y3 | −6.688E+03 | X6Y4 | −2.069E+04 | X5Y5 | −4.098E+03 |
| | | | | | X4Y6 | −2.208E+04 | X3Y7 | 2.361E+03 | X2Y8 | −1.094E+04 |
| | | | | | XY9 | 1.113E+03 | Y10 | −1.261E+03 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | 1.789E−02 | Y | −6.798E−02 | X2 | 1.062E+00 |
| | | | | | XY | −5.951E−01 | Y2 | 1.940E+00 | X3 | −1.069E+00 |
| | | | | | X2Y | 4.159E−01 | XY2 | −8.830E−01 | Y3 | −6.351E−01 |
| | | | | | X4 | 2.292E−01 | X3Y | 4.877E−01 | X2Y2 | 1.595E+00 |
| | | | | | XY3 | 4.415E+00 | Y4 | −3.779E−01 | X5 | −2.869E+00 |
| | | | | | X4Y | −1.921E+00 | X3Y2 | 2.061E+00 | X2Y3 | 1.366E+00 |
| | | | | | XY4 | −6.350E+00 | Y5 | 8.430E−01 | X6 | 5.529E+01 |
| | | | | | X5Y | −3.035E+01 | X4Y2 | 1.048E+02 | X3Y3 | −1.945E+01 |
| | | | | | X2Y4 | 9.418E+01 | XY5 | −2.543E+01 | Y6 | 2.794E+01 |
| | | | | | X7 | 1.374E+02 | X6Y | 7.528E+01 | X5Y2 | −1.932E+02 |
| | | | | | X4Y3 | −2.170E+01 | X2Y4 | 3.579E+01 | X2Y5 | 1.985E+00 |
| | | | | | XY6 | 4.621E+00 | Y7 | −2.386E+01 | X8 | −1.665E+02 |
| | | | | | X7Y | 9.159E+02 | X6Y2 | −1.826E+03 | X5Y3 | 3.327E+02 |
| | | | | | X4Y4 | −1.598E+03 | X3Y5 | 1.393E+02 | X2Y6 | −1.026E+03 |
| | | | | | XY7 | 3.436E+02 | Y8 | −2.925E+01 | X9 | −7.846E+02 |
| | | | | | X8Y | −7.564E+02 | X7Y2 | 2.193E+03 | X6Y3 | 1.439E+03 |
| | | | | | X5Y4 | 4.670E+02 | X4Y5 | −1.750E−02 | X3Y6 | −2.108E+02 |
| | | | | | X2Y7 | 5.079E+01 | XY8 | 3.219E+02 | Y9 | 1.950E+02 |
| | | | | | X10 | 3.942E+02 | X9Y | −8.944E+03 | X8Y2 | 1.764E+04 |
| | | | | | X7Y3 | −3.986E+02 | X6Y4 | 1.611E+04 | X5Y5 | −5.018E+02 |
| | | | | | X4Y6 | 1.492E+04 | X3Y7 | −5.524E+02 | X2Y8 | 6.369E+03 |
| | | | | | XY9 | −2.039E+03 | Y10 | −6.332E+02 | | |

[symbol]

indicates data missing or illegible when filed

TABLE 3E

| HD 90 DEGREE ROTATION | | | | | FREE | | | | | |
|---|---|---|---|---|---|---|---|---|---|---|
| | | | Y | Y | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | 0.9222081 | 0.140 | 0.000 | 0.000 | X: | −5.129E−02 | Y: | −6.074E−02 | X2: | 1.732E−01 |
| 2 | inf | 0.305 | 0.070 | 0.020 | XY: | 8.322E−03 | Y2: | 2.451E−01 | X3: | −3.263E−02 |
| 3 | inf | 0.050 | 0.070 | 0.029 | X2Y: | −4.207E−02 | XY: | −3.526E−02 | Y3: | −6.258E−02 |
| 4 | 0.3580846 | 0.814 | 0.131 | 0.065 | X4: | 1.440E−01 | X3Y: | 1.808E−01 | X2Y2: | 5.066E+01 |
| 5 | 0.4789283 | 0.086 | 0.675 | 0.288 | XY3: | −1.595E−01 | Y4: | 2.368E−01 | X5 | −5.248E−02 |
| 6 | inf | 0.300 | 0.675 | 0.288 | X4Y: | −2.289E−01 | X3Y2: | −2.750E−01 | X2Y3: | −2.570E−01 |
| 7 | inf | 0.076 | 0.675 | 0.288 | XY4: | 1.113E−01 | Y5: | −2.745E−02 | X6: | 3.032E−01 |
| 8 | −0.416998 | 0.123 | 0.928 | 0.346 | X5Y: | 5.213E−01 | X4Y2: | 1.488E+00 | X3Y3: | −4.008E−01 |
| 9 | inf | 0.500 | 1.216 | 0.474 | X2Y4: | 2.217E+00 | XY5: | −9.277E−01 | Y6: | 4.977E−01 |
| 10 | inf | 0.051 | 1.216 | 0.474 | X7: | 2.330E−01 | X6Y: | −5.437E−01 | X5Y2: | 9.164E−01 |
| | | | | | X4Y3: | 4.864E+00 | X3Y4: | −7.021E−01 | X2Y5: | −1.071E+00 |
| | | | | | XY6: | 1.890E+00 | Y7: | −2.813E−01 | X8: | 1.374E+00 |
| | | | | | X7Y: | −5.061E+00 | X6Y2: | −1.493E+01 | X5Y3: | −8.402E+00 |
| | | | | | X4Y4: | −5.0 [symbol] 2E+01 | X3Y5: | 8.011E+00 | X2Y6: | −2.683E+01 |
| | | | | | XY7: | −1.805E+00 | Y8: | −2.439E+00 | X9: | 2.249E+00 |
| | | | | | X6Y: | 6.271E+00 | X7Y2: | −1.184E+01 | X6Y3: | −5.306E+01 |
| | | | | | X5Y4: | 1.103E+01 | X4Y5: | −1.338E+01 | X3Y6: | 1.341E+01 |
| | | | | | X2Y7: | 4.624E+01 | XY8: | −6.680E+00 | Y9: | 6.965E+00 |
| | | | | | X10: | −1.647E+01 | X9Y: | 1.264E+01 | X3Y2: | 1.869E+02 |
| | | | | | X7Y3: | 1.260E+02 | X6Y4: | 7.111E+02 | X5Y5: | −2.391E+00 |
| | | | | | X4Y6: | 5.976E+02 | X3Y7: | −4.830E+01 | X2Y8: | 1.480E+02 |
| | | | | | XY9: | 3.442E+01 | Y10: | 3.118E+00 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | Y: | −2.298E−02 | X2: | −9.948E−01 | XY: | 3.314E−02 |
| | | | | | Y2: | −8.427E−01 | X3: | 1.184E−01 | X2Y: | 3.147E−01 |
| | | | | | XY2: | 2.738E−01 | Y3: | 4.491E−01 | X4: | −2.492E+00 |
| | | | | | X3Y: | 7.778E−01 | X2Y2: | −3.953E+00 | XY3: | −4.206E−01 |
| | | | | | Y4: | −2.009E+00 | X5: | 2.861E−01 | X4Y: | 2.004E+00 |
| | | | | | X3Y2: | 5.358E−01 | X2Y3: | 2.502E+00 | XY4: | 3.430E−01 |
| | | | | | Y5: | 1.010E+00 | X6: | −6.941E+00 | X5Y: | 1.764E+00 |
| | | | | | X4Y2: | −3.189E+01 | X3Y3: | 3.359E+00 | X2Y4: | −3.496E+01 |
| | | | | | XY5: | −1.149E+00 | Y6: | −1.173E+01 | X7: | 2.969E+00 |
| | | | | | X6Y: | −4.960E+01 | X5Y2: | 6.694E+00 | X4Y3: | −4.029E+01 |
| | | | | | X3Y4: | 2.219E+01 | X2Y5: | −1.326E+00 | XY6: | 1.023E+01 |
| | | | | | Y7: | 1.484E+01 | X8: | −9.036E+01 | X7Y: | −1.820E+00 |
| | | | | | X6Y2: | −7.994E+01 | X5Y3: | −1.034E+02 | X4Y4: | −1.579E+02 |
| | | | | | X3Y5: | −7.070E+01 | X2Y6: | 7.324E+01 | XY7: | −1.309E+01 |
| | | | | | Y8: | −4.040E+00 | X9: | 2.786E+01 | X8Y: | 6.013E+02 |
| | | | | | X7Y2: | 1.959E+02 | X6Y3: | 8.620E+02 | X5Y4: | −6.561E+01 |
| | | | | | X4Y5: | 6.569E+02 | X3Y6: | −2.710E+02 | X2Y7: | 1.592E+02 |
| | | | | | XY8: | −1.469E+02 | Y9: | −1.115E+02 | X10: | −2.883E+02 |
| | | | | | X9Y: | −3.923E+02 | X8Y2: | −4.086E+03 | X7Y3: | 2.350E+02 |
| | | | | | X6Y4: | −3.580E+03 | X5Y5: | 2.586E+03 | X4Y6: | −6.822E+03 |
| | | | | | X3Y7: | 4.795E+02 | X2Y8: | −4.836E+03 | XY9: | 5.074E+02 |
| | | | | | Y10: | −4.879E+02 | | | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | Y: | −1.200E−01 | X2: | −7.969E−01 | XY: | −1.122E−01 |
| | | | | | Y2: | −8.439E−01 | X3: | −3.520E−01 | X2Y: | −7.455E−01 |
| | | | | | XY2: | 2.542E−01 | Y3: | −4.794E−01 | X4: | −3.046E+00 |
| | | | | | X3Y: | 2.968E−00 | X2Y2: | −2.978E−00 | XY3: | −5.032E−01 |
| | | | | | Y4: | −2.284E+00 | X5: | 2.702E−01 | X4Y: | −1.008E+00 |
| | | | | | X3Y2: | 3.869E+00 | X2Y3: | 2.464E+00 | XY4: | 2.937E+00 |
| | | | | | Y5: | 2.823E+00 | X6: | 5.548E+00 | X5Y: | 5.086E+00 |
| | | | | | X4Y2: | 5.962E+00 | X3Y3: | 2.363E+00 | X2Y4: | 9.599E+00 |
| | | | | | XY5: | −6.859E−02 | Y6: | 1.143E+01 | X7: | 4.395E+00 |
| | | | | | X6Y: | 2.734E+01 | X5Y2: | −5.033E+00 | X4Y3: | 1.271E+01 |
| | | | | | X3Y4: | −7.869E+00 | X2Y5: | 1.764E+01 | XY6: | −1.301E+01 |
| | | | | | Y7: | −7.343E+00 | X8: | −6.806E+01 | X7Y: | −2.088E+01 |
| | | | | | X6Y2: | −2.412E+02 | X5Y3: | 1.350E+01 | X4Y4: | −2.285E+02 |
| | | | | | X3Y5: | 6.799E−01 | X2Y6: | −2.491E+02 | XY7: | 6.336E+00 |
| | | | | | Y8: | −1.275E+02 | X9: | 7.505E+01 | X8Y: | −1.092E+02 |
| | | | | | X7Y2: | −6.000E+01 | X6Y3: | −8.445E+01 | X5Y4: | −6.846E+00 |
| | | | | | X4Y5: | −1.270E+02 | X3Y6: | 6.181E+00 | X2Y7: | −1.391E+02 |
| | | | | | XY8: | 3.464E+01 | Y9: | 1.344E+01 | X10: | 6.123E+01 |
| | | | | | X9Y: | 8.967E+02 | X8Y2: | −3.488E+02 | X7Y3: | −5.052E−02 |
| | | | | | X6Y4: | 1.230E+03 | X5Y5: | −5.272E+02 | X4Y6: | 1.139E+03 |
| | | | | | X3Y7: | −1.910E+02 | X2Y8: | 7.053E+02 | XY9: | −3.868E+01 |
| | | | | | Y10: | 3.955E+02 | | | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X2: | 1.919E+00 | XY: | −3.778E−01 | Y2: | 1.435E+00 |
| | | | | | X3: | 2.605E−02 | X2Y: | −1.687E+00 | XY2: | 2.318E−01 |
| | | | | | Y3: | −1.163E+00 | X4: | −2.044E+00 | X3Y: | 6.656E+00 |
| | | | | | X2Y2: | 2.400E+00 | XY3: | −1.481E+00 | Y4: | 5.335E−01 |
| | | | | | X5: | −2.645E+00 | X4Y: | 4.335E+00 | X3Y2: | −1.316E+00 |
| | | | | | X2Y3: | 1.063E+00 | XY4: | 2.919E+00 | Y5: | 4.883E+00 |
| | | | | | X6: | 2.883E+01 | X5Y: | −7.697E+00 | X4Y2: | 9.312E+01 |
| | | | | | X3Y3: | −8.388E+00 | X2Y4: | 8.918E+01 | XY5: | −5.330E+00 |
| | | | | | Y6: | 2.368E+01 | X7: | 6.806E+00 | X6Y: | −1.595E+02 |
| | | | | | X5Y2: | −2.665E+01 | X4Y3: | −5.538E+01 | X3Y4: | 8.194E+01 |
| | | | | | X2Y5: | 3.178E+01 | XY6: | −1.008E+01 | Y7: | −1.053E+01 |
| | | | | | X8: | −7.982E−01 | X7Y: | 6.324E+01 | X6Y2: | −3.407E+02 |
| | | | | | X5Y3: | −1.603E+01 | X4Y4: | −1.279E+03 | X3Y5: | 1.097E+01 |
| | | | | | X2Y6: | −9.849E+02 | XY7: | 3.058E−01 | Y8: | −2.100E+02 |
| | | | | | X9: | 3.779E+02 | X8Y: | 1.457E+03 | X7Y2: | 6.346E+02 |
| | | | | | X6Y3: | 1.397E+03 | X5Y4: | −7.076E−01 | X4Y5: | −2.317E+00 |
| | | | | | X3Y6: | −2.093E+02 | X2Y7: | −2.141E+02 | XY8: | 6.833E+01 |
| | | | | | Y9: | −4.904E+01 | X10: | −2.590E+02 | X9Y: | −1.236E+03 |
| | | | | | X8Y2: | −2.272E+03 | X7Y3: | −1.840E+03 | X6Y4: | 7.906E+03 |
| | | | | | X5Y5: | 7.324E+02 | X4Y6: | 1.060E+04 | X3Y7: | −1.234E+02 |
| | | | | | X2Y8: | 5.755E+03 | XY9: | −1.060E+02 | Y10: | 9.897E+02 |

[symbol]

indicates data missing or illegible when filed

TABLE 3F

| D1 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | 1.2052701 | 0.179 | 0.000 | 0.000 | X | −1.503E−01 | Y | −1.820E−02 | X2 | 1.481E−01 |
| 2 | inf | 0.305 | 0.062 | 0.072 | XY | 5.171E−05 | Y2 | 2.364E−01 | X3 | −3.973E−05 |
| 3 | inf | 0.050 | 0.062 | 0.072 | X2Y | 2.215E−02 | XY2 | 4.181E−04 | Y3 | 8.330E−03 |
| 4 | 0.3279198 | 0.849 | 0.132 | 0.149 | X4 | 1.059E−01 | X3Y | 7.962E−04 | X2Y2 | 5.188E−01 |
| 5 | 0.4782498 | 0.054 | 0.651 | 0.644 | XY3 | 3.031E−03 | Y4 | 2.135E−04 | X5 | −1.426E−04 |
| 6 | inf | 0.300 | 0.651 | 0.644 | X4Y | −8.646E−02 | X3Y2 | 3.051E−03 | X2Y3 | −6.310E−02 |
| 7 | inf | 0.097 | 0.651 | 0.644 | XY4 | −9.572E−03 | Y5 | 1.490E−01 | X6 | 4.921E−01 |
| 8 | −0.41984 | 0.101 | 0.905 | 0.703 | X5Y | 2.246E−02 | X4Y2 | 2.064E+00 | X3Y3 | 1.799E−02 |
| 9 | inf | 0.500 | 1.152 | 0.884 | X2Y4 | 2.224E+00 | XY5 | −3.816E−02 | Y6 | 5.927E−01 |
| 10 | inf | 0.050 | 1.152 | 0.884 | X7 | 6.678E−04 | X6Y | 7.171E−01 | X5Y2 | −3.800E−02 |
| | | | | | X4Y3 | −7.353E−01 | X3Y4 | 1.386E−01 | X2Y5 | −1.834E+00 |
| | | | | | XY6 | 4.722E−02 | Y7 | −4.578E−01 | X8 | −3.851E+00 |
| | | | | | X7Y | −3.278E−01 | X6Y2 | −1.128E+01 | X5Y3 | −5.266E−03 |
| | | | | | X4Y4 | −1.464E+01 | X3Y5 | −1.031E+00 | X2Y6 | −1.340E+01 |
| | | | | | XY7 | 5.227E−02 | Y8 | −2.628E+00 | X9 | 3.096E−02 |
| | | | | | X8Y | 1.792E+01 | X7Y2 | −1.206E+00 | X6Y3 | 5.553E+01 |
| | | | | | X5Y4 | −1.963E+00 | X4Y5 | 4.062E+01 | X3Y6 | 4.309E+00 |
| | | | | | X2Y7 | −9.256E+00 | XY8 | 6.265E−01 | Y9 | 3.247E−01 |
| | | | | | X10 | 1.153E+01 | X9Y | −8.218E+00 | X8Y2 | 7.569E+01 |
| | | | | | X7Y3 | −1.225E+01 | X6Y4 | 7.654E+01 | X5Y5 | −3.033E+01 |
| | | | | | X4Y6 | 1.818E+02 | X3Y7 | 3.217E+00 | X2Y8 | 4.423E+01 |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | −5.390E−02 | Y | −1.049E−02 | X2 | −1.304E+00 |
| | | | | | XY | 4.648E−02 | Y2 | −1.148E+00 | X3 | 2.776E−01 |
| | | | | | X2Y | 2.817E−02 | XY2 | 3.713E−01 | Y3 | 3.417E−01 |
| | | | | | X4 | −4.159E+00 | X3Y | 3.211E−02 | X2Y2 | −5.343E+00 |
| | | | | | XY3 | 3.046E−01 | Y4 | −2.896E+00 | X5 | −1.035E+00 |
| | | | | | X4Y | 1.064E+01 | X3Y2 | −2.687E−01 | X2Y3 | 3.698E+00 |
| | | | | | XY4 | −1.583E+00 | Y5 | −8.636E−01 | X6 | −4.041E−01 |
| | | | | | X5Y | 9.560E+00 | X4Y2 | −6.442E+01 | X3Y3 | −1.169E+01 |
| | | | | | X2Y4 | −8.198E+01 | XY5 | −4.151E+00 | Y6 | −1.245E+01 |
| | | | | | X7 | −3.142E−03 | X6Y | −2.656E+02 | X5Y2 | −9.404E−02 |
| | | | | | X4Y3 | 6.440E+00 | X3Y4 | 1.396E+02 | X2Y5 | −4.700E+01 |
| | | | | | XY6 | 5.829E+01 | Y7 | 4.363E+01 | X8 | −1.627E+01 |
| | | | | | X7Y | 7.570E−02 | X6Y2 | 5.417E+01 | X5Y3 | −5.144E−01 |
| | | | | | X4Y4 | −1.015E+03 | X3Y5 | −5.523E−03 | X2Y6 | 1.829E+02 |
| | | | | | XY7 | −3.215E−03 | Y8 | −2.267E+02 | X9 | −1.674E−01 |
| | | | | | X8Y | 2.947E+01 | X7Y2 | 1.318E−01 | X6Y3 | −1.942E+02 |
| | | | | | X5Y4 | 1.305E+00 | X4Y5 | 1.015E+02 | X3Y6 | 4.296E−01 |
| | | | | | X2Y7 | −5.385E+01 | XY8 | −1.065E−01 | Y9 | −2.055E+02 |
| | | | | | X10 | 1.333E+02 | X9Y | 5.210E+00 | X8Y2 | −2.898E+02 |
| | | | | | X7Y3 | −1.806E+01 | X6Y4 | 5.520E+02 | X5Y5 | 2.873E+00 |
| | | | | | X4Y6 | 1.884E+02 | X3Y7 | 7.897E−01 | X2Y8 | −3.562E+02 |
| | | | | | XY3 | −3.939E−01 | Y10 | −3.786E+01 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | 5.115E−02 | Y | −9.121E−02 | X2 | −7.754E−01 |
| | | | | | XY | −9.796E−02 | Y2 | −1.077E+00 | X3 | −4.416E−01 |
| | | | | | X2Y | −1.190E+00 | XY2 | 3.538E−01 | Y3 | −7.686E−01 |
| | | | | | X4 | −4.534E+00 | X3Y | −5.164E−01 | X2Y2 | −3.157E+00 |
| | | | | | XY3 | 1.555E+00 | Y4 | −8.927E−01 | X5 | −4.414E−01 |
| | | | | | X4Y | −3.785E+00 | X3Y2 | −1.791E−01 | X2Y3 | 1.620E+00 |
| | | | | | XY4 | −5.501E−01 | Y5 | 5.808E+00 | X6 | 3.126E+01 |
| | | | | | X5Y | −2.188E+00 | X4Y2 | 3.041E+00 | X3Y3 | −1.409E+01 |
| | | | | | X2Y4 | 3.458E+00 | XY5 | −2.445E−03 | Y6 | −5.155E+00 |
| | | | | | X7 | 2.556E−02 | X6Y | 2.117E+01 | X5Y2 | −1.113E+02 |
| | | | | | X4Y3 | −3.537E+01 | X3Y4 | 6.657E+01 | X2Y5 | 2.923E+01 |
| | | | | | XY6 | 8.418E−02 | Y7 | −8.276E+01 | X8 | −3.698E+02 |
| | | | | | X7Y | 3.465E−02 | X6Y2 | −6.231E+02 | X5Y3 | 3.525E−01 |
| | | | | | X4Y4 | −1.440E+02 | X3Y5 | −1.216E−01 | X2Y6 | −2.287E+02 |
| | | | | | XY7 | −2. [symbol] 51E+01 | Y8 | −4.787E+01 | X9 | 2.382E−03 |
| | | | | | X8Y | −2.438E+02 | X7Y2 | −5.081E−01 | X6Y3 | −8.200E+01 |
| | | | | | X5Y4 | −3.359E−01 | X4Y5 | −1.266E+02 | X3Y6 | 1.617E+00 |
| | | | | | X2Y7 | −2.208E+02 | XY8 | 1.967E−01 | Y9 | 4.137E+02 |
| | | | | | X10 | 1.758E+03 | X9Y | −2.271E+00 | X8Y2 | 8.767E+02 |
| | | | | | X7Y3 | 1.862E+00 | X6Y4 | 1.968E+03 | X5Y5 | 2.385E+00 |
| | | | | | X4Y6 | 1.282E+03 | X3Y7 | −2.724E+00 | X2Y8 | 1.031E+03 |
| | | | | | XY9 | −1.000E+00 | Y10 | 3.599E+02 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | −4.283E−04 | Y | −3.215E−02 | X2 | 2.003E+00 |
| | | | | | XY | −1.209E−04 | Y2 | 1.165E+00 | X3 | −2.680E−04 |
| | | | | | X2Y | −1.932E+00 | XY2 | −1.084E−03 | Y3 | −8.510E−01 |
| | | | | | X4 | −2.891E+00 | X3Y | 3.983E−03 | X2Y2 | 3.601E+00 |
| | | | | | XY3 | 1.714E−03 | Y4 | 2.321E+00 | X5 | 6.120E−03 |
| | | | | | X4Y | 2.694E−00 | X3Y2 | −1.465E−02 | X2Y3 | −2.248E+00 |
| | | | | | XY4 | 7.988E−03 | Y5 | 2.223E+00 | X6 | 4.380E+01 |
| | | | | | X5Y | 1.008E−02 | X4Y2 | 6.944E+01 | X3Y3 | 6.270E−02 |
| | | | | | X2Y4 | 9.703E+01 | XY5 | 6.229E−02 | Y6 | 2.004E+01 |
| | | | | | X7 | 8.757E−02 | X6Y | −1.995E+02 | X5Y2 | −2.734E−01 |
| | | | | | X4Y3 | −5.042E+01 | X3Y4 | 4.367E−01 | X2Y5 | 7.235E+01 |
| | | | | | XY6 | −1.257E−01 | Y7 | −1.832E+01 | X8 | −2.139E+02 |
| | | | | | X7Y | 1.709E+00 | X6Y2 | −3.154E+02 | X5Y3 | −5.113E−01 |
| | | | | | X4Y4 | −1.261E+03 | X3Y5 | 8.526E−01 | X2Y [symbol] | −1.030E+03 |
| | | | | | XY7 | −1.094E+00 | Y8 | −2.169E+02 | X9 | 6.529E−01 |
| | | | | | X8Y | 1.718E+03 | X7Y2 | −5.369E+00 | X6Y3 | 1.648E+03 |
| | | | | | X5Y4 | 3.031E+00 | X4Y5 | −6.258E+02 | X3Y6 | −7.979E−01 |
| | | | | | X2Y7 | −2.917E+02 | XY8 | −5.399E−01 | Y9 | −4.715E+01 |
| | | | | | X10 | −1.480E+03 | X9Y | −1.136E+01 | X8Y2 | −2.847E+03 |
| | | | | | X7Y3 | −2.218E+01 | X6Y4 | 7.360E+03 | X5Y5 | −4.795E+00 |
| | | | | | X4Y6 | 1.130E+04 | X3Y7 | 1.380E+01 | X2Y8 | 5.363E+03 |
| | | | | | XY9 | −2.840E+00 | Y10 | 8.617E+02 | | |

[symbol]

indicates data missing or illegible when filed

TABLE 3G

| D2 90 DEGREE ROTATION | | | | | FREE | | | | | |
|---|---|---|---|---|---|---|---|---|---|---|
| | | | Y | X | SPHERICAL | | | | | |
| FACE | RADIUS OF | DIS- | ECCEN- | ECCEN- | SURFACE | FIRST | | | | |
| NUMBER | CURVATURE | TANCE | TRICITY | TRICITY | COEFFICIENT | FACE | | | | |
| 1 | −20.27163 | 0.160 | 0.000 | 0.000 | X | −2.735E−02 | Y | −2.815E−02 | X2 | 8.084E−01 |
| 2 | inf | 0.305 | 0.030 | 0.025 | XY | −4.412E+04 | Y2 | 8.226E−01 | X3 | −3.091E−02 |
| 3 | inf | 0.050 | 0.030 | 0.025 | X2Y | 7.910E−02 | XY2 | 2.259E−02 | Y3 | 9.559E−03 |
| 4 | 0.3492195 | 0.845 | 0.060 | 0.054 | X4 | 4.825E−01 | X3Y | −9.001E−02 | X2Y2 | 9.484E−01 |
| 5 | 0.4252009 | 0.056 | 0.357 | 0.277 | XY3 | −1.070E−01 | Y4 | 4.411E−01 | X5 | −8.017E−02 |
| 6 | inf | 0.300 | 0.357 | 0.277 | X4Y | 7.946E−02 | X3Y2 | −1.971E−01 | X2Y3 | 3.980E−03 |
| 7 | inf | 0.053 | 0.357 | 0.277 | XY4 | −2.035E−02 | Y5 | −4.887E−02 | X6 | 1.401E+00 |
| 8 | −0.403322 | 0.146 | 0.456 | 0.332 | X5Y | 1.649E+00 | X4Y2 | 7.842E−01 | X3Y3 | 3.422E+00 |
| 9 | inf | 0.500 | 0.616 | 0.417 | X2Y4 | 2.378E+00 | XY5 | 1.169E+00 | Y6 | 2.131E+00 |
| 10 | inf | 0.050 | 0.616 | 0.417 | X7 | 6.048E−01 | X6Y | 8.043E−01 | X5Y2 | 2.035E+00 |
| | | | | | X4Y3 | 3.813E+00 | X3Y4 | 1.509E+00 | X2Y5 | 3.471E+00 |
| | | | | | XV6 | 1.010E+00 | Y7 | 7.547E−01 | X8 | −5.753E+00 |
| | | | | | X7Y | −1.477E+01 | X6Y2 | 1.484E+01 | X5Y3 | −5.287E+01 |
| | | | | | X4Y4 | 1.961E+01 | X3Y5 | −4.915E+01 | X2Y6 | −9.601E+00 |
| | | | | | XY7 | −1.053E+01 | Y8 | −1.103E+01 | X9 | −2.682E+00 |
| | | | | | X8Y | −7.414E−01 | X7Y2 | −1.124E+01 | X6Y3 | −3.405E+00 |
| | | | | | X5Y4 | −1.918E+01 | X4Y5 | −2.382E+01 | X3Y6 | −1.025E+01 |
| | | | | | X2Y7 | −1.300E+01 | XY8 | −2.829E+00 | Y9 | −2.588E+00 |
| | | | | | X10 | 2.745E+01 | X9Y | 3.684E+01 | X8Y2 | 3.419E+00 |
| | | | | | X7Y3 | 1.875E+02 | X6Y4 | −3.292E+01 | X5Y5 | 2.964E+02 |
| | | | | | X4Y6 | 2.856E+01 | X3Y7 | 1.558E+02 | X2Y8 | 9.043E+01 |
| | | | | | XY9 | 2.081E+01 | Y10 | 3.895E+01 | | |
| | | | | | FREE | | | | | |
| | | | | | SPHERICAL | | | | | |
| | | | | | SURFACE | FOURTH | | | | |
| | | | | | COEFFICIENT | FACE | | | | |
| | | | | | X | −1.822E−02 | Y | −6.579E−03 | X2 | −9.842E−01 |
| | | | | | XY | 2.300E−04 | Y2 | −9.577E−01 | X3 | 1.070E−01 |
| | | | | | X2Y | 4.557E−01 | XY2 | 2.721E−01 | Y3 | 2.761E−01 |
| | | | | | X4 | −1.516E+00 | X3Y | 8.989E−02 | X2Y2 | −3.040E+00 |
| | | | | | XY3 | 6.998E−03 | Y4 | −1.451E+00 | X5 | 1.050E+00 |
| | | | | | X4Y | 1.792E+00 | X3Y2 | 1.741E+01 | X2Y3 | 3.207E+00 |
| | | | | | XY4 | 1.306E+00 | Y5 | 1.713E+00 | X6 | −3.615E+01 |
| | | | | | X5Y | 6.904E+00 | X4Y2 | −1.083E+02 | X3Y3 | 1.333E+01 |
| | | | | | X2Y4 | −1.092E+02 | XY5 | 5.951E+00 | Y6 | −3.613E+01 |
| | | | | | X7 | −5.404E+00 | X6Y | −5.370E+00 | X5Y2 | −1.296E+01 |
| | | | | | X4Y3 | −8.544E+00 | X3Y4 | −8.051E+00 | X2Y5 | −1.931E+01 |
| | | | | | XY6 | −4.268E+00 | Y7 | −1.199E+01 | X8 | 4.266E+02 |
| | | | | | X7Y | −9.285E+01 | X6Y2 | 1.713E+03 | X5Y3 | −3.495E+02 |
| | | | | | X4Y4 | 2.531E+03 | X3Y5 | −3.105E+02 | X2Y6 | 1.764E+03 |
| | | | | | XY7 | −9.587E+01 | Y8 | 4.332E+02 | X9 | 7.041E+01 |
| | | | | | X8Y | 1.417E+02 | X7Y2 | 2.861E+02 | X6Y3 | 3.644E+02 |
| | | | | | X5Y4 | 3.276E+02 | X4Y5 | 5.134E+02 | X3Y6 | 2.177E+02 |
| | | | | | X2Y7 | 4.365E+02 | XY8 | 8.460E+01 | Y9 | 1.347E+02 |
| | | | | | X10 | −3.543E+03 | X9Y | 5.620E+02 | X8Y2 | −1.733E+04 |
| | | | | | X7Y3 | 2.891E+03 | X6Y4 | −3.472E+04 | X5Y5 | 4.310E+03 |
| | | | | | X4Y6 | −3.538E+04 | X3Y7 | 2.344E+03 | X2Y8 | −1.832E+04 |
| | | | | | XY9 | 5.925E+02 | Y10 | −3.557E+03 | | |
| | | | | | FREE | | | | | |
| | | | | | SPHERICAL | | | | | |
| | | | | | SURFACE | FIFTH | | | | |
| | | | | | COEFFICIENT | FACE | | | | |
| | | | | | X | −3.232E−02 | Y | 1.275E−02 | X2 | −1.103E+00 |
| | | | | | XY | −1.767E−01 | Y2 | −1.063E+00 | X3 | −8.707E−01 |
| | | | | | X2Y | −2.149E−01 | XY2 | −1.612E−01 | Y3 | −6.021E−01 |
| | | | | | X4 | −2.919E+00 | X3Y | 1.793E+00 | X2Y2 | −4.183E+00 |
| | | | | | XY3 | 1.355E+00 | Y4 | −2.711E+00 | X5 | 3.633E+00 |
| | | | | | X4Y | 6.692E−03 | X3Y2 | 1.290E+00 | X2Y3 | 5.020E+00 |
| | | | | | XY4 | −3.614E+00 | Y5 | 3.852E+00 | X6 | 2.253E+01 |
| | | | | | X5Y | −6.566E+00 | X4Y2 | −2.391E+01 | X3Y3 | 2.768E−01 |
| | | | | | X2Y4 | −3.065E+01 | XY5 | −1.008E+01 | Y6 | 1.315E+01 |
| | | | | | X7 | −2.500E+01 | X6Y | 8.360E+01 | X5Y2 | −2.163E+00 |
| | | | | | X4Y3 | 1.874E+01 | X3Y4 | 5.735E+01 | X2Y5 | −1.427E+01 |
| | | | | | XY6 | 9.950E+01 | Y7 | −2.609E+01 | X8 | −3.263E+02 |
| | | | | | X7Y | 3.181E−02 | X6Y2 | 7.019E+01 | X5Y3 | 1.920E+02 |
| | | | | | X4Y4 | 6.395E+02 | X3Y5 | 8.215E+01 | X2Y6 | 4.019E+02 |
| | | | | | XY7 | 2.690E+02 | Y8 | −1.647E−02 | X9 | 1.474E+02 |
| | | | | | X8Y | −2.251E+02 | X7Y2 | 2.523E+02 | X6Y3 | −5.711E+02 |
| | | | | | X5Y4 | −2.893E+02 | X4Y5 | 1.570E−02 | X3Y6 | −4.463E+02 |
| | | | | | X2Y7 | 6.248E+01 | XY8 | −4.948E+02 | Y9 | 1.790E+02 |
| | | | | | X10 | 1.102E+03 | X9Y | −1.424E+03 | X8Y2 | −5.640E+02 |
| | | | | | X7Y3 | −2.494E+03 | X6Y4 | −5.482E+03 | X5Y5 | −1.527E+03 |
| | | | | | X4Y6 | −5.698E+03 | X3Y7 | −5.549E+02 | X2Y8 | −3.483E+03 |
| | | | | | XY9 | −1.572E+03 | Y10 | 6.050E+02 | | |
| | | | | | FREE | | | | | |
| | | | | | SPHERICAL | | | | | |
| | | | | | SURFACE | EIGHTH | | | | |
| | | | | | COEFFICIENT | FACE | | | | |
| | | | | | X | 7.207E−02 | Y | 1.059E−01 | X2 | 1.738E+00 |
| | | | | | XY | −4.124E−01 | Y2 | 1.650E+00 | X3 | −1.069E+00 |
| | | | | | X2Y | −6.941E−01 | XY2 | 1.144E−02 | Y3 | −1.085E+00 |
| | | | | | X4 | 1.487E+00 | X3Y | 3.669E+00 | X2Y2 | −1.525E−01 |
| | | | | | XY3 | 1.894E+00 | Y4 | 9.069E−01 | X5 | 9.375E−01 |
| | | | | | X4Y | 1.019E+00 | X3Y2 | 2.311E+00 | X2Y3 | 9.258E+00 |
| | | | | | XY4 | −5.139E+00 | Y5 | 5.497E+00 | X6 | −2.581E+01 |
| | | | | | X5Y | −4.513E+01 | X4Y2 | 1.419E+02 | X3Y3 | −2.190E+01 |
| | | | | | X2Y4 | 1.144E+02 | XY5 | −1.367E+01 | Y6 | 2.158E+01 |
| | | | | | X7 | −9.945E+00 | X6Y | −4.375E+01 | X5Y2 | −9.018E+01 |
| | | | | | X4Y3 | −6.883E+01 | X3Y4 | 1.097E+01 | X2Y5 | −1.189E+02 |
| | | | | | XY6 | 3.850E+01 | Y7 | −4.558E+01 | X8 | 1.443E+03 |
| | | | | | X7Y | 4.906E−02 | X6Y2 | −2.042E+03 | X5Y3 | 6.173E+02 |
| | | | | | X4Y4 | −2.078E+03 | X3Y5 | 1.846E+01 | X2Y6 | −1.207E+03 |
| | | | | | XY7 | 1.549E+02 | Y8 | −1.050E+02 | X9 | 4.208E+02 |
| | | | | | X8Y | 7.067E+02 | X7Y2 | 1.065E+03 | X6Y3 | 4.722E+02 |
| | | | | | X5Y4 | 9.800E+00 | X4Y5 | 4.765E+02 | X3Y6 | −9.269E+01 |
| | | | | | X2Y7 | 6.743E+02 | XY8 | 8.370E+01 | Y9 | 2.252E+02 |
| | | | | | X10 | −1.418E+04 | X9Y | −4.116E+02 | X8Y2 | 1.296E+04 |
| | | | | | X7Y3 | −5.141E+03 | X6Y4 | 1.831E+04 | X5Y5 | −1.294E+03 |
| | | | | | X4Y6 | 1.695E+04 | X3Y7 | 5.782E+02 | X2Y8 | 7.085E+03 |
| | | | | | XY9 | −3.806E+02 | Y10 | 8.787E+02 | | |

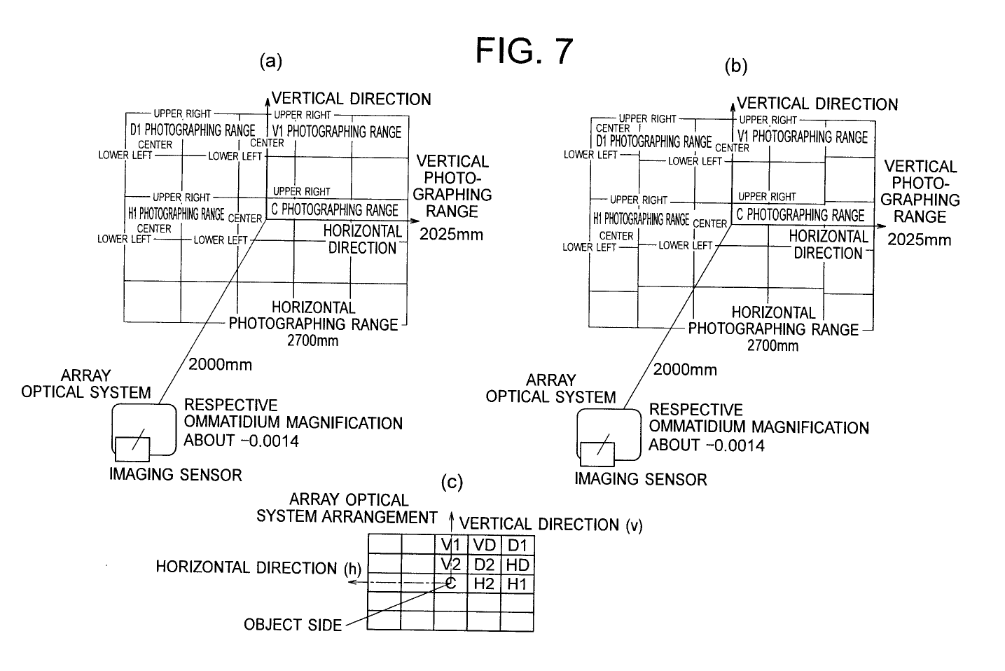

FIG. 7(a) is a schematic diagram showing a photographing range of a comparative example, FIG. 7(b) is a schematic diagram showing a photographing range of an example, and FIG. 7(c) is a drawing showing an arrangement of a compound eye optical system. Table 4 is a table showing the photographing range and optical system data of each of the ommatidium lenses in the example, and Table 5 is a table showing the photographing range and optical system data of each of the ommatidium lenses in the comparative example.

TABLE 4
Example

| V1 photographing range | VD photographing range | D1 photographing range |
|---|---|---|
| horizontal (h): 378~−378 (10.7°~−10.7°) | horizontal (h): 891~378 (24.0°~10.7°) | horizontal (h): 1350~891 (34.0°~24.0°) |
| vertical (v): 1012.5~607.5 (26.9°~16.9°) | vertical (v): 1012.5~607.5 (26.9°~16.9°) | vertical (v): 1012.5~729 (26.9°~20.0°) |
| ηh = 0.38, ηv = 0.20 | ηh = 0.26, ηv = 0.20 | ηh = 0.23, ηv = 0.14 |
| * first face apex position (0, 2.075) | * first face apex position (−1.636, 2.015) | * first face apex position (−2.777, 2.111) |
| V2 photographing range | D2 photographing range | HD photographing range |
| horizontal (h): 378~−378 (10.7°~−10.7°) | horizontal (h): 891~378 (24.0°~10.7°) | horizontal (h): 1350~891 (34.0°~24.0°) |
| vertical (v): 607.5~202.5 (16.9°~5.8°) | vertical (v): 607.5~202.5 (16.9°~5.8°) | vertical (v): 729~243 (20.0°~−6.9°) |
| ηh = 0.38, ηv = 0.20 | ηh = 0.26, ηv = 0.20 | ηh = 0.23, ηv = 0.24 |
| * first face apex position (0, 1.065) | * first face apex position (−1.586, 0.983) | * first face apex position (−2.838, 1.251) |
| C1 photographing range | H2 photographing range | H1 photographing range |
| horizontal (h): 378~−378 (10.7°~−10.7°) | horizontal (h): 891~378 (24.0°~10.7°) | horizontal (h): 1350~891 (34.0°~24.0°) |
| vertical (v): 202.5~−202.5 (5.8°~− 5.8°) | vertical (v): 202.5~−202.5 (5.8°~−5.8°) | vertical (v): 243~−243 (6.9°~−6.9°) |
| ηh = 0.38, ηv = 0.20 | ηh = 0.26, ηv = 0.20 | ηh = 0.23, ηv = 0.24 |
| * first face apex position (0, 0) | * first face apex position (−1.636, 0) | * first face apex position (−2.787, 0) |

 The numerical values in the table represent the coodinates of (h, v). However, (0, 0) is the same with the center position of an imaging sensor.

TABLE 5
Comparative Example

| V1 photographing range | VD photographing range | D1 photographing range |
|---|---|---|
| horizontal (h): 270~−270 (7.7°~−7.7°) | horizontal (h): 810~270 (22.1°~7.7°) | horizontal (h): 1350~810 (34.0°~22.1°) |
| vertical (v): 1012.5~607.5 (26.9°~16.9°) | vertical (v): 1012.5~607.5 (26.9°~16.9°) | vertical (v): 1012.5~607.5 (26.9°~16.9°) |
| ηh = 0.27, ηv = 0.20 | ηh = 0.27, ηv = 0.20 | ηh = 0.27, ηv = 0.20 |
| * first face apex position (0, 2.082) | * first face apex position (−1.368, 2.005) | * first face apex position (−2.664, 2.018) |
| V2 photographing range | D2 photographing range | HD photographing range |
| horizontal (h): 270~−270 (7.7°~−7.7°) | horizontal (h): 810~270 (22.1°~7.7°) | horizontal (h): 1350~810 (34.0°~22.1°) |
| vertical (v): 607.5~202.5 (16.9°~5.8°) | vertical (v): 607.5~202.5 (16.9°~5.8°) | vertical (v): 607.5~202.5 (16.9°~5.8°) |
| ηh = 0.27, ηv = 0.20 | ηh = 0.27, ηv = 0.20 | ηh = 0.27, ηv = 0.20 |
| * first face apex position (0, 1.059) | * first face apex position (−1.372, 0.984) | * first face apex position (−2.728, 1.041) |
| C1 photographing range | H2 photographing range | H1 photographing range |
| horizontal (h): 270~−270 (7.7°~−7.7°) | horizontal (h): 810~270 (22.1°~7.7°) | horizontal (h): 1350~810 (34.0°~22.1°) |
| vertical (v): 202.5~−202.5 (5.8°~−5.8°) | vertical (v): 202.5~−202.5 (5.8°~−5.8°) | vertical (v): 202.5~−202.5 (5.8°~−5.8°) |
| ηh = 0.27, ηv = 0.20 | ηh = 0.27, ηv = 0.20 | ηh = 0.27, ηv = 0.20 |
| * first face apex position (0, 0) | * first face apex position (−1.406, 0) | * first face apex position (−2.687, 0) |

 The numerical values in the table represent the coodinates of (h, v). However, (0, 0) is the same with the center position of an imaging sensor.

Herein, with reference to Table 4, since ·h_c=0.38 and ··_c=0.20 in the central ommatidium lens (c1) in the example, the relationship with the photographing range of each of the peripheral portions is as follows.

V1: ·h_{—}c=·h_{—}d,·v_{—}c=·v_{—}d,·h_{—}d/·h_{—}c=1,·v_{—}d/·v_{—}c=1

V2: ·h_{—}c=·h_{—}d,·v_{—}c=·v_{—}d,·h_{—}d/·h_{—}c=1,·v_{—}d/·v_{—}c=1

VD: ·h_{—}c>·h_{—}d,·v_{—}c=·v_{—}d,·h_{—}d/·h_{—}c=0.68,·v_{—}d/·v_{—}c=1

D2: ·h_{—}c>·h_{—}d,·v_{—}c=·v_{—}d,·h_{—}d/·h_{—}c=0.68,·v_{—}d/·v_{—}c=1

H2: ·h_{—}c>·h_{—}d,·v_{—}c=·v_{—}d,·h_{—}d/·h_{—}c=0.68,·v_{—}d/·v_{—}c=1

D1: ·h_{—}c>·h_{—}d,·v_{—}c>·v_{—}d,·h_{—}d/·h_{—}c=0.61,·v_{—}d/·v_{—}c=7

HD: ·h_{—}c>·h_{—}d,·v_{—}c<·v_{—}d,·h_{—}d/·h_{—}c=0.61,·v_{—}d/·v_{—}c=1.2

H1: ·h_{—}c>·h_{—}d,·v_{—}c<·v_{—}d,·h_{—}d/·h_{—}c=0.61,·v_{—}d/·v_{—}c=1.2

Therefore, the photographing ranges VD, D2, H2, D1, HD, and H1 of the peripheral portions satisfy the following formula (1), and the photographing range D1 of the peripheral portions satisfies the following formula (2). On the other hand, with reference to Table 5, the photographing range of the comparative examples is an equal division, and in the respective photographing ranges of all the peripheral portions, ·h_c=·h_d and ··_c=··_d.

·h_{—}c>·h_{—}d (1)

··_{—}c>··_{—}d (2)

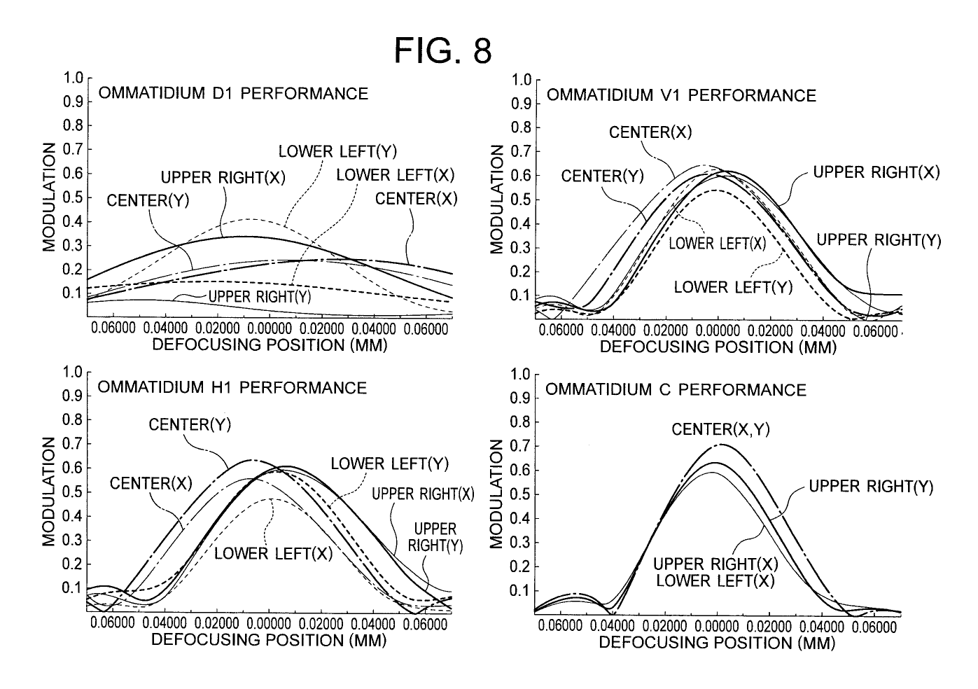

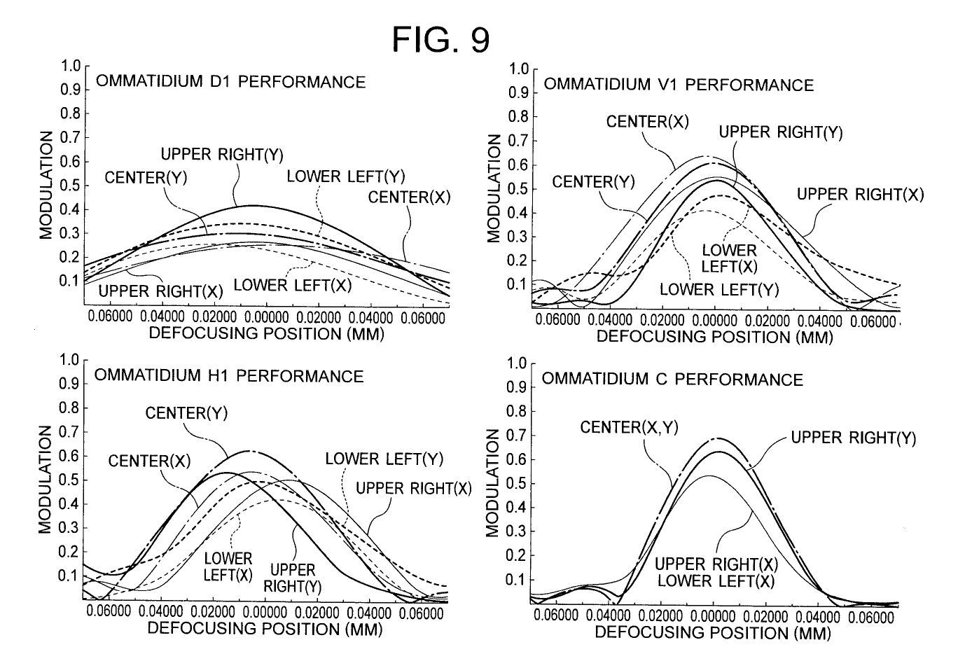

FIGS. 8(a), 8(b), 8(c), and 8(d) are diagrams where respective MTF values in photographing ranges D1, V1, H1, and C in the comparative examples are graphed respectively. FIGS. 9(a), 9(b), 9(c), and 9(d) are diagrams where respective MTF values in photographing ranges D1, V1, H1, and C in the examples are graphed respectively. In the comparison between the same photographing ranges among FIGS. 8(a) to ((d) and FIGS. 9(a) to 9(d), the followings are clear. In particular, the examples have been improved more than the comparative examples in terms of the MTF peak values and the image surface quality in the photographing ranges of the peripheral portions, whereby the effects of the present invention have been confirmed.

Hereafter, preferable embodiments are explained collectively.

In the above-mentioned compound eye optical system, it is preferable that at least one of the formula (3) and the formula (4) is established.

0.9··h_{—}d/·h_{—}c·0.4 (3)

0.9···_{—}d/··_{—}c·0.4 (4)

In the case where the value of the formula (3) or the formula (4) is equal to or less than the upper limit value, it becomes possible to make an amount of an image surface curvature in the photographing range region smaller by narrowing the photographing range of the peripheral ommatidium lens relative to the photographing range of the central ommatidium lens. Accordingly, it becomes possible to make an amount of an eccentricity of a lens surface (or a lens group) smaller. As a result, it becomes possible to make an ommatidium lens which has little defocus and a good image forming performance, and it becomes possible to constitute a compound eye optical system with a good image forming performance. On the other hand, in the case where the value of the formula (3) or the formula (4) is equal to or more than the lower limit value, the photographing range of the central ommatidium lens is not likely to be taken too wide. Accordingly, it becomes possible to provide a compound eye optical system with a good optical performance in which an amount of an image surface curvature is not large also in the range photographed by the central ommatidium lens.

It is preferable to dispose three or more of the above-mentioned ommatidium lenses side by side in each of the horizontal direction and the vertical direction. With this constitution, the photographing range of each of the ommatidium lenses can be made small. Accordingly, it becomes possible to make an amount of an image surface curvature at the boundary of the photographing ranges smaller, and it becomes possible to enable a compound eye optical system to have a good image forming performance.

It is preferable that the above-mentioned ommatidium lens includes at least two lenses and at least one surface of the above-mentioned peripheral ommatidium lens includes a free curved surface. With this, it becomes possible to enable the compound eye optical system to have a good image forming performance.

It is preferable that the respective magnifications of the above-mentioned ommatidium lenses are almost the same with each other. With this, at the time of processing images formed via the respective ommatidium lenses, it becomes unnecessary to align or make the respective magnifications of the images uniform. Accordingly, connecting processing of the images becomes simple and the imaging device can be made low cost.

It is preferable to dispose a light shielding stop between the above-mentioned ommatidium lenses and an image surface. By disposing the light shielding stop, the constitution can be made so as to prevent light rays from entering a portion other than an imaging surface corresponding to each of the ommatidium lenses (to prevent a cross talk). Accordingly, the compound eye optical system can be made to have a good image forming performance.

It is clear for a person skilled in the art from the embodiments, the examples, and the technical concepts described in the present description that the present invention should not be limited to the embodiments and the examples described in the present description and includes another embodiment and modified examples. The description and example in the specification (description) are intended originally to show exemplification, and the scope of the present invention is shown by claims mentioned later.

### REFERENCE SIGNS LIST

1 Image Processing Section
1a Image synthesizing section
1b Image correcting section
1c Output image processing unit
2 Lens
3 Memory
AP Light shielding member
AX Optical axis
CG Cover glass
DL1 Central ommatidium lens
DL2 Peripheral ommatidium lens
LA1 Lens array
LA2 Lens array
LH Compound eye optical system
Ln Ommatidium lens
LU Imaging unit
SR Imaging sensor

1. A compound eye optical system for use in an imaging device which includes an image processing section configured to connect images formed with respective different view fields on a single solid state imaging sensor so as to output an image formed on a single sheet, comprising:
an array lens including multiple lenses which are formed integrally into a single sheet and have respective different optical axes,
wherein multiple ommatidium lenses configured to form images correspondingly to respective view fields are constituted by the lenses of the array lens, and at least one of Formula (1) and Formula (2) is established.
ηh_{—}c>ηh_{—}d (1)
ηv_{—}c>ηv_{—}d (2)
ηh_c: the horizontal direction photographing range of a central ommatidium lens located on a central side of the array lens
ηh_d: the horizontal direction photographing range of a peripheral ommatidium lens located closer to a peripheral side of the array lens rather than the central ommatidium lens
ηv_c: the vertical direction photographing range of the central ommatidium lens located on the central side of the array lens
ηv_d: the vertical direction photographing range of the peripheral ommatidium lens located closer to the peripheral side of the array lens rather than the central ommatidium lens

2. The compound eye optical system, wherein at least one of Formula (3) and Formula (4) is established.
0.9≧ηh_{—}d/ηh_{—}c≧0.4 (3)
0.9≧ηv_{—}d/ηv_{—}c≧0.4 (4)

3. The compound eye optical system described in claim 1, wherein three or more of the ommatidium lenses are disposed side by side in each of the horizontal direction and the vertical direction.

4. The compound eye optical system described in claim 1, wherein each of the ommatidium lenses includes at least two lenses, and the peripheral ommatidium lens includes a free curved surface on at least one surface.

5. The compound eye optical system described in claim 1, wherein the ommatidium lenses have the almost same magnification to each other.

6. The compound eye optical system described in claim 1, further comprising a light shielding stop between the ommatidium lenses and an image surface.

7. An imaging device, comprising:
the compound eye optical system described in claim 1,
a solid state imaging sensor, and
an image processing section.
